(19) United States
(12) Patent Application Publication
(10) Pub. No.: US 2024/0046798 A1
(43) Pub. Date: Feb. 8, 2024

(54) METHOD AND APPARATUS FOR AUTOMATED VEHICLE PLATOONING

(71) Applicants: Cristian Oara, Bucharest (RO); Florin Stoican, Costesti (RO)

(72) Inventors: Cristian Oara, Bucharest (RO); Florin Stoican, Costesti (RO)

(21) Appl. No.: 16/615,766

(22) PCT Filed: May 21, 2018
(86) PCT No.: PCT/IB2018/053564

§ 371 Date: Nov. 21, 2019

Related U.S. Application Data
(60) Provisional application No. 62/509,437, filed on May 22, 2017.

(51) Int. Cl. G08G 1/00; B60W 30/165; B60W 40/06; B60W 40/105; B60W 50/14; G05D 1/02

(52) U.S. Cl. CPC G08G 1/22; B60W 30/165; B60W 40/06; B60W 40/105; B60W 50/14; G05D 1/0293; B60W 2050/0083

(57) ABSTRACT

A platooning control arrangement in which a signal for use in controlling the action of at least one of the brake and throttle is sent from at least one vehicle of the platoon to at least one other vehicle of the platoon where the control signal is represented with respect to a model of a standardized vehicle, and the receiving vehicle applies its brakes or throttle based on the received control signal. The model of a standardized vehicle is known to at least the sending and receiving vehicles. Compensation may be applied for delays in the control signal's path. Advantageously, the platoon may be a heterogeneous platoon and each vehicle in the platoon can have its brake and throttle properly controlled without needing to know anything about the dynamical model of any vehicle in the platoon other than its own. Abnormal road conditions may also be detected.

### CROSS REFERENCE TO RELATED APPLICATIONS

This application claims priority to and benefit from U.S. Provisional Patent Application No. 62/509,437 filed on May 22, 2017 which is incorporated herein by reference for all that it teaches.

### TECHNICAL FIELD

The present invention generally relates to automated control of a vehicle platoon and, more specifically, to an automatic control mechanism for maneuvering a heterogeneous platoon of vehicles on roadways while guaranteeing collision avoidance.

### BACKGROUND

Vehicle platooning designates a plurality of vehicles traveling together in a line, single file, one after another, along the same direction of a roadway. As is the case with all road traffic, each vehicle must be able to maintain at all times a certain, prespecified interspacing distance with respect to the preceding vehicle, in order to avoid collisions.

Automated vehicle platooning refers to vehicle platooning where some specific task pertaining to the vehicle's navigation on the roadway (usually the breaking and throttling actions but sometimes steering as well) is performed (at least in part) without human intervention.

A vehicle traveling in front of a current vehicle in the direction of travel is referred to as a preceding vehicle or predecessor vehicle with respect to the current vehicle. A vehicle traveling behind a current vehicle in the direction of travel is called a following vehicle or follower vehicles with respect to the current vehicle. The first vehicle in the platoon, i.e. the vehicle that has no predecessor vehicles but only follower vehicles, is called the leader vehicle.

Automated platooning for road vehicles may have important economic and societal benefits such as a significant decrease in the number of fatal road accidents, reducing highways congestions by increasing traffic throughput, and improving fuel consumption via reduction of the air drag to the vehicles.

While performing automated platooning each vehicle may be equipped with one or more of the following components: electro-hydraulic brake, throttle actuators, ranging sensors such as lidar or radar, wireless communications systems, e.g. dedicated short range communications, such as IEEE 802.11p, high accuracy clocks, and onboard digital controllers.

Using information from the sensors, the clocks, and the communications module, the controller onboard each vehicle must produce in real time the necessary steering and braking/throttling maneuvers that would maintain a specified interspacing distance between any two consecutive vehicles in the platoon.

In platooning, the velocity of the leader vehicle represents a reference for the entire platoon, since only when all vehicles in the platoon maintain the same velocity as each other, such velocity being equal to the leader's velocity, so that the vehicles of the platoon exist in a state that is known as velocity agreement, do the interspacing distances between any two consecutive vehicles remain constant.

The desired, prespecified interspacing distances between any two consecutive vehicles in the platoon must be maintained irrespective of any change over time of the velocity of the leader vehicle.

To be practical, a method for controlling platooning vehicles on a roadway must be able to function in the presence of road disturbances. Examples of road disturbances include: an incline or decline of the surface of the road, different conditions of tire rolling friction, and air drag of the vehicle which may depend not only on the vehicle's speed but also on atmospheric conditions.

In the automated platooning framework the following elements may also be considered road disturbances: the velocity profile of the leader vehicle, non-zero initial conditions for the errors of the interspacing distances; and the maneuvers performed by the vehicles when merging in and exiting from the platoon.

Since safety is a primary goal for road platooning, it is preferable to avoid methods based on Global Positioning Systems (GPS) or differential GPS, i.e. the use of GPS for obtaining relative coordinates, due to their having problems with regards to reliability and location accuracy, as well as having relatively large latency in certain traffic conditions. Similar difficulties with reliability are also found with longitudinal accelerometers for automotive applications, e.g., such accelerometers may have offset errors, they may be sensitive to temperature differences, and they may have low accuracy due to a vehicle's pitch movement during deceleration/acceleration maneuvering.

The navigation task of any road vehicle may be decomposed in two distinct parts: (1) lateral control, i.e. steering or lane keeping and (2) longitudinal control, i.e. breaking/throttling maneuvers, respectively. While lane keeping may be performed at each vehicle in a manner independent of the other vehicles in the platoon (for instance by using specialized perception sensors able to recognize the traffic lanes marked on the surface of the highway), the longitudinal control (the control of the brake and throttle) has to be performed with respect to the other vehicles in the platoon, within a generic framework known as displacement-based formation control. It is precisely the fact that longitudinal control (braking and throttling) at the current vehicle must be performed in a manner dependent on the brake and throttle actions of preceding vehicles, that stays at the root of most difficulties and problems related to vehicle platooning.

It is a well understood phenomenon in automated platooning that several, serious technical difficulties arise in the cases of relatively “long” platoons traveling in “tight” formations where the length of a platoon relates to the number of vehicles in the platoon and the tightness of formation refers to inter-vehicle spacing. More specifically, the longitudinal control problem, i.e., the problem of properly controlling the brake and the throttle in each vehicle, becomes increasingly more difficult with each vehicle added to the back end of the platoon. The technical difficulties are further complicated when the vehicles must maintain relatively small interspacing distances, i.e., a tight formation, and these interspacing policies are not made to be proportional to the speed of the vehicles. One such difficulty relates to the propagation of road disturbances throughout the platoon and is known in the platooning art as so called “string instabilty”, e.g., the Forrester or bullwhip effect, which describes the amplification of a disturbance at a vehicle propagating towards the back of the platoon, in a manner dependent of the number of vehicles in the platoon.

During automated platooning ranging sensors on board a vehicle gather information with respect to the interspacing distances of neighboring, e.g., preceding or following, vehicles. There are various methods available to perform longitudinal control in automated platooning, but the most commonly employed in the prior art are those for which the longitudinal control for the current vehicle is performed based on: (a) the interspacing distance with respect to the preceding vehicle, (b) the interspacing distances with respect to both the preceding and the following vehicle, and (c) the interspacing distances with respect to multiple predecessor vehicles, so called “multi look ahead schemes”.

Measuring in real time the interspacing distances with respect to the immediate predecessor and the immediate follower is performed in practice using widely available, reliable, and affordable ranging sensors. However, practical problems arise when attempting to measure the interspacing distances with respect to, for example, multiple predecessor vehicles. These problems are caused by the physical imitations of existing ranging sensors but also by the fact that, in general, predecessor vehicles are often situated beyond the direct line of sight of the current vehicle. This often renders impractical the measurement on board the current vehicle of the interspacing distances with respect to multiple, e.g., more than two or three, predecessor vehicles.

In certain variants of a recent set of methods known in platooning as cooperative adaptive cruise control (CACC), a control signal can be generated to maintain a desired distance between the vehicle and the predecessor vehicle within a formation of platooning vehicles. The control signal may be based on both the measured distance with respect to the predecessor vehicle and on a communication received from the predecessor vehicle. The control signal is fed into the brake and throttle actuators in order to produce a control action for the vehicle, such as to maintain a desired distance between the vehicle and the predecessor vehicle.

The various variants of CACC may differ among them by the choice of the information received, typically via wireless communications, from the predecessor vehicle. In some variants an internal state, e.g. a speed or an acceleration, of the predecessor is received while in other variants the control action performed at the brake/throttle actuators of the predecessor is received.

In certain CACC variants, a method for operating a vehicle within a formation of platooning vehicles includes receiving, e.g., via a wireless communications ink, a control signal from a predecessor vehicle or receiving, via a wireless communications ink, control signals from multiple predecessor vehicles.

An excessive amount of vehicle-to-vehicle (V2V) communications, which is communications between any two vehicles in the platoon, will result, in general, in interference problems and also in well known problems associated with ad-hoc wireless networks which manifest during merging of vehicles into the platoon and during exiting of vehicles from the platoon. Under these circumstances, restricting the V2V communications to be only between neighboring vehicles is strongly preferred.

Wireless communication induced time delays and time jittering are known to possibly cause severe deteriorations of the performance and safety guarantees of most platooning methods, up to the point of rendering them unusable. Consequently, practical methods to cope with and compensate for the aforementioned time delays and time jittering phenomena, which are inherent to V2V based schemes, are useful.

The platoon may be heterogeneous, i.e., have at least two different vehicle types in the platoon, or it may be homogenous where all the vehicles in the platoon are similar vehicle types.

The vast majority of automated platooning methods in the prior art deal with the case of homogenous platoons, i.e. the situation in which al vehicles in the platoon formation have identical or highly similar dynamical models. A dynamic model describes a vehicle's dynamic properties and may be modeled as a dynamical system. Such properties include, but are not limited to, mass, drive train characteristics, electro-hydraulic brake and throttle actuators, tire rolling friction coefficients and aerodynamic profile. Such properties essentially determine the dynamic response of the vehicle to a throttle or brake action, e.g., on a flat roadway. The electro-hydraulic brake and throttle actuators may be coupled in cascade with additional equipment, such as a specially designed digital controller that performs a linearization of the torque versus speed characteristic of the vehicle and turns the actuator setpoints into acceleration of the vehicle setpoints.

In order to make automated platooning widely available to the general pubic, it is necessary to have systems that are able to deal with heterogeneous platoons, and in particular platoons where any make and model of vehicle may be participants. For certain existing methods that are able to deal with heterogeneous platoons, especially CACC type methods, the current vehicle might need to have access to information about the dynamical models of the neighboring vehicles. Making such information available to the current vehicle, might require the additional use of V2V communications. There is also the delicate issue of ‘data privacy’, since some vehicle owners might not agree to make information about their vehicle dynamical model known to other vehicles in the platoon formation.

From an engineering perspective, a convoy of road vehicles performing automated platooning represents a complex cyber-physical system that is an aggregation of many components, such as drive trains, electro-hydraulic actuators, ranging sensors, wireless communications and digital computers. Guaranteeing the reliability and secure functioning of such complex cyber-physical systems in “real life” road conditions, while known to be a challenging task from an engineering point of view, is a critical requirement for enabling the pubic to begin to use of automated platooning.

If automated platooning technology become widely available to the general pubic then it may be desirable that the safety and reliability requirements related to its practical exploitation are comparable in rigor to the requirements put forth by regulatory agencies for civilian aviation. This means that the technology should be able to cope with the possibilty of faults or failures at critical hardware components, such as the ranging sensors, brake/throttle mechanisms, or V2V communications modules. Furthermore, effective countermeasures are needed to prevent premeditated actions of sabotaging the platooning platforms through sensors spoofing or V2V communications hacking or jamming such as might be undertaken by criminals.

The equilibrium state of the platoon is defined to be the state in which the desired, prespecified interspacing distances between any two consecutive vehicles in the platoon are maintained with a zero error. While all vehicles in the platoon are functioning in the automated platooning mode, the road disturbances continuously cause the displacement of the state of the platoon away from its equilibrium state to a state with non-zero errors in the interspacing distances between two consecutive vehicles. Obviously, the occurrence of large errors in the interspacing distances between any two consecutive vehicles in the platoon formation is undesirable, since it can lead to collisions.

The effect of the road disturbances on the amplitude of the errors of the interspacing distances between two consecutive vehicles in the platoon is in general a measure of performance of the automated control method used for platooning. However, it is inevitable that heavy road disturbances will cause large errors in the interspacing distances, regardless of the performance of the platooning control method. An example of a strong road disturbance, which is a road disturbance that possess high energy, is a very steep decline or incline in the surface of a highway. In this case the energy of the disturbance takes the form of gravitational potential. Another example of a strong road disturbance would be an emergency, e.g., full or maximum braking maneuver of the leader vehicle. In this case the energy takes the form of the kinetic energy of the leader, as the leader's velocity profile represents the reference for the entire platoon.

A high accuracy evaluation of the adverse effects of road disturbances on the maximal amplitude of the errors of the interspacing distances between two consecutive vehicles in the platoon is therefore important for establishing which methods of automated platooning control are safe in that their use does not lead to collisions.

A maximal amplitude or an upper bound, e.g., for a “worst case scenario” of the energy contained in road disturbances can be established by performing a large set of measurements on vehicles in real-life highway/roadway traffic. Henceforth, the term “abnormal road conditions” will be used to denote the presence of road disturbances whose energetic amplitude exceeds the aforementioned, established upper bound.

A road disturbance whose energy is below the aforementioned established upper bound, and therefore is not an abnormal road condition, is said to be a normal road condition.

Prior art systems cannot handle long vehicle heterogenous platoons, which are platoons that are made up of two or more types of vehicles that have distinct dynamics, while employing V2V communications only between neighboring vehicles and at the same time cope with uncertainty in the dynamical models or parameters of the vehicles, take into account road disturbances and accommodate relatively small inter-vehicle spacing distances at highway speeds, e.g., a spacing of only several feet, without increasing the likelihood of collision to unacceptable levels.

Also, prior art systems based on CACC type methods cannot handle heterogeneous platoons when the current vehicle does not communicate or make available any of the details of its dynamic model to any other vehicle in the platoon.

For example, with reference to a CACC type method functioning within a heterogenous platoon, the data exchanged among the vehicles via a wireless communications ink may include the control signal of a predecessor vehicle, wherein the predecessor vehicle is of a different type or has different dynamical characteristics than the current vehicle. Both the predecessor vehicle's dynamical model and its control signal are necessary in order to establish a meaningful interpretation of the control actions produced by the control signal. This is because a control signal of 10 kN which here reflects a force to be applied via the drive train or the brake mechanism, will produce a certain effect on, for example, a 1500 kg Toyota Prius and another, completely different, effect on, for example, an 3000 kg Chevrolet Suburban.

For example, a heterogenous platoon might include vehicles with different masses and vehicles whose hydraulic throttle actuators coupled to their corresponding drive trains can be modeled as a first order linear and time invariant dynamical system, with distinct time constants. However, the vehicles in the platoon may choose to not make available or communicate among themselves their masses or the time constants of their hydraulic actuators.

In addition, those CACC-type prior art systems which are capable of handing heterogenous platoons which typically has at least one vehicle communicate or make available at least some of the details of its dynamic model to at least one other vehicle in the platoon, are extremely sensitive to communication induced time delays and time jittering, which are known to be detrimental to the overall reliability and performance of the platoon control, especially when employed for long platoons.

Lastly, prior art systems are not capable of detecting abnormal road conditions that are potentially dangerous in real time and on board of each vehicle in the platoon.

### SUMMARY OF THE INVENTION

The foregoing imitations of prior art systems with regard to their need to communicate or make available at least some of the details of the dynamic model or dynamic properties of the current vehicle to at least one other vehicle in the platoon can be overcome, in accordance with the principles of the invention, by an improved platooning control arrangement in which a signal for use in controlling the action of at least one of the brake and throttle is sent from at least one vehicle of the platoon to at least one other vehicle of the platoon where the control signal is represented with respect to a model of a standardized vehicle, and the receiving vehicle applies its brakes or throttle based on the received control signal. The model of a standardized vehicle is known, or made available, to at least the vehicle sending the control signal and the vehicle receiving the control signal and in some embodiments of the invention to all of the vehicles of the platoon. Advantageously, the platoon may be a heterogeneous platoon and each vehicle in the platoon can have its brake and throttle properly controlled without needing to know anything about the dynamical model of any vehicle in the platoon other than its own.

In accordance with an embodiment of the invention, the action taken at the vehicle receiving the control signal is based at least in part on the received control signal and on a determined distance between the receiving vehicle and the transmitting vehicle, so as to maintain a desired distance between the vehicle and the transmitting vehicle.

In another embodiment of the invention, the control action to be taken at the receiving vehicle may be computed onboard the transmitting vehicle based at least in part on the control signal of the transmitting vehicle and on a distance between the receiving vehicle and the transmitting vehicle.

In accordance with an aspect of the invention, the model of a standardized vehicle may represent a dynamical model of a “standardized model” vehicle. Such a “model” vehicle need not be for any vehicle in actually the platoon or and it may be a virtual model in that it need not correspond to any actually existing vehicle. In accordance with an embodiment of the invention, the model of a standardized vehicle may be of a “model” vehicle that has a mass of 100 kg. and a one second time constant of the first order linear dynamical system modeling the hydraulic actuators of the “model” vehicle for both the brake and the throttle.

As indicated, the control signal is used to control at least one of the brake and the throttle in the receiving vehicle. In accordance with an aspect of the invention, the control signal may be a unified numerical signal that is a number and, based on the value of the number, specifies the brake or throttle to be applied. For example, in one embodiment of the invention, the value of the control signal may range from between 100 and +100, where −100 indicates to apply full brake and +100 indicates to apply full throttle. However, when the intervehicle distance is determined at the receiving vehicle, the actual control action for the brake or throttle is derived based on the control signal using a function thereof that also takes into account the interspacing distance between the transmitting vehicle and the receiving vehicle.

In accordance with an aspect of the invention, for each value of the control signal to be sent the sending vehicle first develops an initial value for the control signal with respect to its own dynamical model and then translates each initial value into a corresponding value for the standardized vehicle dynamical model. In other words, the control signal as sent represents the equivalent control action as was developed for the sending vehicle based on its own dynamical model but when effectuated on the standardized dynamical vehicle. The receiving vehicle performs the counterpart reverse process by taking the received control signal value and translating it, based on the receiving vehicle's dynamical model, into a final signal that is applied to control the application of the brake or throttle.

The braking mechanism of some of the vehicles in the platoon may be modeled as a first or second order dynamical system distinct from the dynamic system assimilated to the vehicle's hydraulic throttle actuator, corresponding to a representation known in the prior art as switched dynamical systems. In accordance with an aspect of the invention, the control signal of the vehicle for either braking or throttle actions may be modeled with respect to the dynamical model of the standardized vehicle.

In one embodiment of the invention, the control signal is received by the current vehicle in the platoon and it is developed in and sent from the immediate predecessor of the current vehicle. Such is done in S. Sabau, C. Oara, S. Wamick, A Jadbabaie “Optimal Distributed Control for Platooning via Sparse Coprime Factorizations”, IEEE Trans. Automatic Control, Vol. 62, No. 1, pp. 305-320, which is incorporated by references as if fully set forth herein.

In embodiments of the invention, the control signal and the final signal are developed based on forms of scaling or normalization that are performed on dynamical systems. In embodiments of the invention, dynamical model inversion methods may be employed to develop the transmitted control signal from the initial version of the control signal based on the sending vehicle's dynamical model. In embodiments of the invention, a dynamical model inversion method may be implemented as a filtered variant of the initial values of the control signal as developed for the sending vehicle based on the sending vehicle's own dynamical model.

As is well known, various abnormal road conditions can upset the operation of a platoon. In addition, we have recognized that various hardware failures can be treated as if they are abnormal road conditions. Such hardware failures may include, for example, malfunction of the ranging sensors, malfunctioning of the actuators, or malfunctions of the communications. Such malfunctions may be temporary, e.g., due to weather conditions, or permanent, e.g., due to hardware failure. Such malfunctions may also be the product of hacking, e.g., conveying a false signal to the vehicle. Therefore, in accordance with an aspect of the invention, given a mechanism for operating a follower vehicle in a vehicle platoon, e.g., as described above, wherein a control signal is generated on board the vehicle in order to maintain a desired distance between the vehicle and a predecessor vehicle within a platoon of vehicles, a quantitative analysis and evaluation of the effect of road disturbances on the interspacing distance with respect to the predecessor vehicle may be performed. In response to detection of abnormal road conditions a distinctive human perceivable warning signal, e.g. audio signal or visual signal, may be provided to the human operator or to the human supervisor of the vehicle while at the same time the vehicle's speed is reduced or the vehicle is safely brought to a full stop.

In accordance with an aspect of the invention, the quantitative analysis and evaluation allows for the determination and computation in real time of the set of all possible evolutions in time under normal road conditions of certain signals of interest for the operation of the platoon of vehicles such as, but not limited to, the error of the interspacing distances between consecutive vehicles or the relative speeds of a vehicle with respect to at least one of its predecessor vehicles.

In accordance with an aspect of the invention, use is made of the known concept of set invariance. Positive or controlled invariant sets characterize the dynamic evolution of the platoon of vehicles whose automated functioning on the roadway is performed by a mechanism for operating the vehicles platoon. By dynamic evolution it is understood the evolution over time of the position, speeds and accelerations of vehicles as well as the relative positions and relative speeds of the vehicles in the platoon. Robust positively invariant (RPI) sets are bounded subsets or regions of the state space of a dynamical model. For example a vehicle's dynamical model may include states such as the evolution in time of the vehicle speed and acceleration of the vehicle. The state-space of a dynamical model for the platoon of vehicles as a whole may include states such as the interspacing distances between vehicles in the platoon and the relative speeds of the vehicles. The invariance property guarantees the evolution of certain states of the models that are needed to control the operation of the platoon such as the error of the interspacing distances or the relative speeds, towards the interior of the RPI sets and furthermore it guarantees that once they reach the interior of the RPI sets, the aforementioned signals will remain inside the RPI sets throughout the duration of functioning of the platooning mechanism under normal road conditions. The invariance property will provide guarantees that certain pre-determined bounds on the aforementioned signals will remain valid at all times during the functioning of the platooning mechanism under normal road conditions.

The RPI sets for use with the abnormal road conditions detection may be computed at the design stage of the mechanism. The computation of the RPI sets and the design of the mechanism used to detect abnormal road conditions may be performed in conjunction with the mechanism used to operate the vehicle platoon on the roadway.

Due to the invariant properties of the RPI sets, any violations of the subsequent constraints can be interpreted as an occurrence of abnormal road conditions. That is, if the signal of interest “escapes” the bounds of its RPI set it means that (1) either a road disturbance that exceeds the upper bound allowed for “normal” road conditions was encountered or (2) that a change took place in the closed loop dynamics of the mechanism. This can be assumed because, as indicated above, the invariance property guarantees that the signal cannot escape its bounding RPI set once it had entered in it.

In accordance with an aspect of the invention the detection mechanism is based on a signal known in fault tolerant control systems as a “residual” which is sensitive to variations above a certain, prespecified threshold of the amplitude of road disturbance encountered by the vehicle and is also sensitive to changes in the closed loop dynamics of the mechanism controlling the brake and throttle of the vehicle. Consequently, the residual signal contains critical information that enables the detection of the aforementioned variations above the prespecified threshold. In this context by “closed loop” we understand for example the feedback loop from the control signal of the vehicle to the interspacing distances with respect to vehicles transmitting data to the vehicle, or to relative speeds with respect to vehicles transmitting data to the vehicle.

A choice for the residual may be the vehicle interspacing errors, as it represents an important aspect of functioning of the platoon pertaining to safety and reliability and it may be a measurement used in the development of the control signal that is typically used in the method for operating the platoon of vehicles.

In accordance with an aspect of the invention, the abnormal road conditions detecting mechanism aggregates known information from the platooning vehicle, which may be obtained, for example, from sensor measurements, wirelessly communicated data, or reference inputs, into residual signals. Residuals signals are sensitive to variations above a certain threshold in the amplitude of disturbances and to changes in the closed loop dynamics but not to the usual model variations or model uncertainty nor to measurement and process noises.

The problem pertaining to communications and computation induced time delays and time jittering related to transmitting the control signal from one vehicle to the other with CACC-type systems is overcome, in accordance with the principles of the invention by an arrangement in which the longitudinal control mechanism regulates a constructed version of a signal based on the interspacing distance between any two specified vehicles of the platoon, e.g., two consecutive vehicles, by appropriately applying the throttle and/or break based on the control signal received from the transmitting vehicle.

For example, when [symbol] ₖ(t) denotes the evolution in time of the absolute coordinate on the roadway, e.g., with respect to an inertial reference system, of the k-th vehicle in the platoon then [symbol] ₖ₋₁(t)− [symbol] ₖ(t) represents the distance at time t between the k th vehicle and its predecessor, the (k 1)-th vehicle. This latter signal may be determined onboard the k-th vehicle, for example, by using forward looking sensors or onboard the (k−1)-th vehicle using rearward looking sensors. Such intervehicle spacing must be property controlled as it represents an important safety and reliability functioning parameter at the k-th vehicle. However, if a control signal uₖ₋₁(t) is transmitted by the (k−1)-th vehicle, e.g. via wireless communications, a θ seconds delayed version uₖ₋₁(t−θ) of the transmitted signal is what is actually received and becomes at the k-th vehicle. Such communication and computation induced time delay is inherent to wireless communications, being caused by the physical imitations of existing equipment. In accordance with an embodiment of the invention, the signal [symbol] ₖ₋₁(t−θ)− [symbol] ₖ(t), represents the constructed version of the interspacing distance between the k th vehicle and the (k−1)-th vehicle that is to be controlled. Preferably, θ is measured with high accuracy, e.g., with less than a millisecond of error. In an exemplary embodiment, the regulated signal [symbol] ₖ₋₁(t−θ)− [symbol] ₖ(t) can be developed onboard the k-th vehicle using a ranging sensor for measuring [symbol] ₖ₋₁(t)− [symbol] ₖ(t) in real time; a high accuracy speedometer, synchronized clocks and a numerical integrator.

In accordance with an embodiment of the invention, the constructed version of the interspacing distance may be taken with respect to the k-th vehicle and another vehicle in the platoon, not necessarily the (k−1)-th vehicle.

The constructed signal can be developed on board the current vehicle by subtracting the integration of the absolute speed of the vehicle over a θ length interval from a θ delayed measurement of the interspacing distance with respect to the transmitting vehicle. The constructed signal may be regulated by applying the throttle or the brake using the control action signal of the current vehicle based, for example, on a received control signal at the current vehicle, the relative speed of the current with respect to the transmitting vehicle, an artificial potential function, a supplemental correction term, which may be an acceleration correction term, e.g., for the current vehicle.

In accordance with an embodiment of the invention, the regulated signal may be a derivative with respect to the time variable t of the constructed version of the interspacing distance [symbol] ₖ₋₁(t−θ)− [symbol] ₖ(t), which corresponds to a constructed version of the relative speed between the vehicles.

### BRIEF DESCRIPTION OF THE DRAWING

In the drawing:

FIG. 1 shows an illustrative group of vehicles 110A-110D that are arranged into a platoon wherein at least two of the vehicles of the platoon operate in accordance with the principles of the invention;

FIG. 2 shows an illustrative set of components which may be present in one or more of the vehicles of FIG. 1 for use in implementing the principles of the invention;

FIG. 3 shows an illustrative process for generating a control signal in a sending vehicle of a platoon for use in controlling the action of at least one of the brake and throttle of at least one other vehicle of the platoon where the control signal is represented with respect to a dynamical model of a standardized vehicle in accordance with the principles of the invention;

FIG. 4 shows an illustrative process for using a control signal received at a vehicle to control the action of at least one of the brake and throttle of the receiving vehicle where the control signal is represented with respect to a model of a standardized vehicle in accordance with the principles of the invention;

FIG. 5 shows an illustrative process of the “offline”, i.e., design stages of a mechanism for detecting abnormal road conditions for a platoon of vehicles, in accordance with an aspect of the invention;

FIG. 6 shows a representation of the first three vehicles of a platoon such as the platoon shown in FIG. 1;

FIG. 7 shows a classical framework in control engineering that represents a standard unity feedback configuration of the plant G with the controller K where G is a multivariable Linear and Time Invariant (LTI) plant and K is an LTI controller in which aspects of the invention may be implemented;

FIG. 8 is a representation of two consecutive vehicles in a platoon; and

FIG. 9 shows a control system capable of taking into account communications and computation induced time delays by regulating a constructed version of a signal based on the interspacing distance between any two specified vehicles of the platoon, in accordance with the principles of the invention.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without Imitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry or components embodying the principles of the invention. Similarly, it will be appreciated that any flow charts, flow diagrams, state transition diagrams, pseudocode, process descriptions and the like represent various processes which may be substantially represented in computer readable medium and so executed by a computer or processor, whether or not such computer or processor is explicitly shown.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. A processor may have one or more so called “processing cores”. Moreover, explicit use of the term “processor” or “controller” should not be construed to refer exclusively to hardware capable of executing software, and may implicitly include, without Imitation, digital signal processor (DSP) hardware, network processor, application specific integrated circuit (ASIC), field programmable gate array (FPGA), graphics processing unit (GPU), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

In the description, identically numbered components within different ones of the FIGs. refer to the same components.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “selecting”, “assigning”, “estimating”, “determining”, or the like, refer to the action and processes of a computer system, or similar computing device, that manipulates and transforms data represented as physical, e.g., electronic, quantities within the computer system's registers and memories into other data similarly represented as physical quantities within the computer system memories or registers or other such information storage, transmission, or display devices.

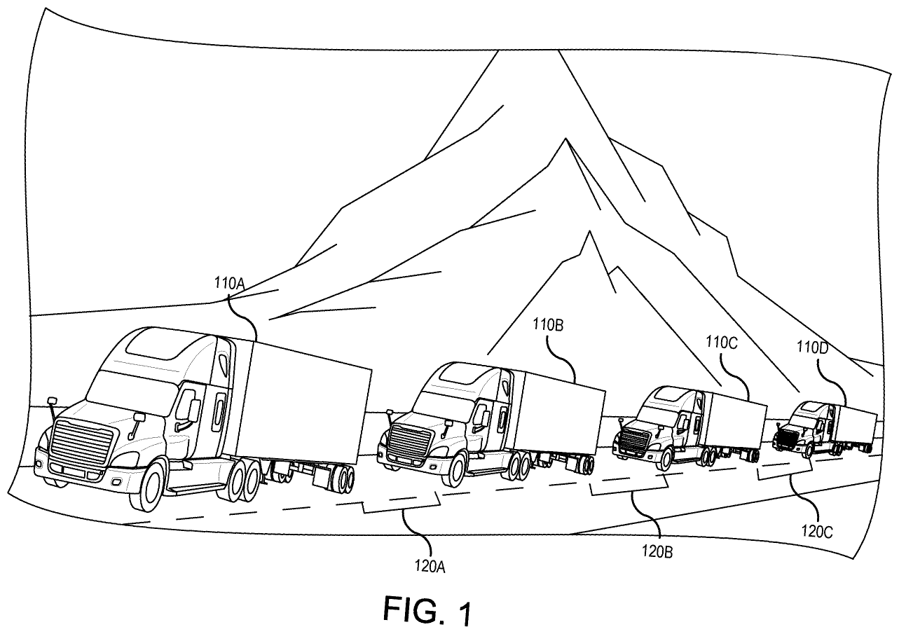

FIG. 1 shows an illustrative group of vehicles 110A-110D that are arranged into a platoon wherein at least two of the vehicles of the platoon operate in accordance with the principles of the invention. While FIG. 1 only shows four vehicles, vehicles 110A-110D may be part of a larger platoon with more vehicles than illustrated in FIG. 1. Vehicle 110A is the lead vehicle which is in front of all of the subsequent, i.e., follower, vehicles 110B-110D which are arranged one behind the other. A controller on board each vehicle can be used to maintain the desired intervehicle spacing distances 120A-120C. These distances may be fixed or may change depending on various conditions, e.g., weather conditions, communication quality, weight of the vehicle, vehicle dynamics, braking abilities, and the like. For example, interspacing distances 120A 120C may increase when the roads are wet or snowy.

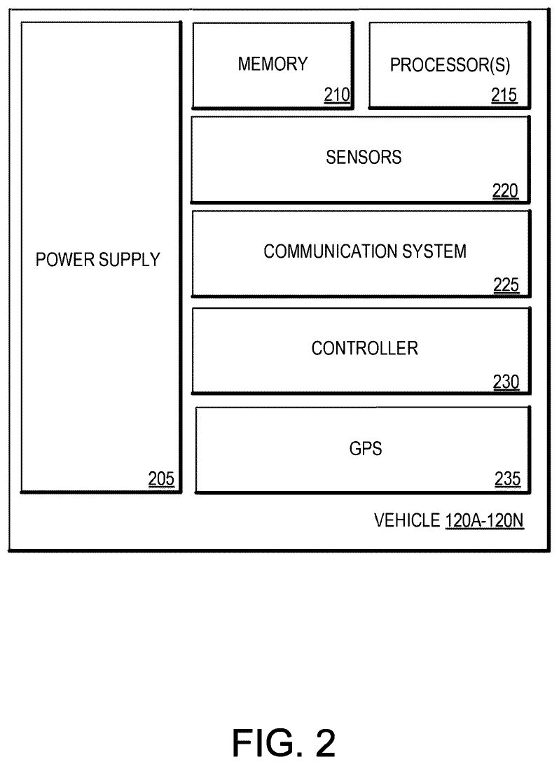

FIG. 2 shows an illustrative of a set of components which may be present in one or more of vehicles 110A-110D (FIG. 1) for use in implementing the principles of the invention. As shown in FIG. 2 vehicle 110A-110D may a) include power supply 205, e.g., a battery, generator and so forth, b) memory 210, e.g., any type of volatile memory and/or nonvolatile memory used for storing information, processor 215 for executing instructions and performing calculations, c) sensors 220, d) communication system 225, e) controller 230, and f) global positioning system (GPS) 235. These components may be interconnected via conventional interconnection methods.

Memory 210 may be used to store instructions for running one or more applications or modules on processors 215. Processor(s) 215 may be communicably coupled with memory 210 and configured to run or otherwise communicate with the operating system, user interfaces, sensors 220, communication system 225, controller 230, GPS 235, and/or other components.

Sensors 220 may be used to sense conditions in the surrounding environment and produce a corresponding signal that can be acted upon by various components within the vehicle or transmitted to other vehicles within the platoon or global monitoring infrastructure. In some embodiments, sensors 220 may include one or more of the following: speedometer, accelerometer, camera, infrared sensors, ranging sensors, motion sensors, LIDAR, RADAR, gyroscopes, and the like. For example, a ranging sensor can be used to measure the distance to the predecessor vehicle. In some embodiments, optical ranging devices such as Hilti PD-40/PD-42 or one of the Leica Disto Series, e.g., D2, D5, or D8, could be used. The optical ranging devices may be associated with optical target plates mounted on the back of each vehicle in order to improve ranging performance. The optical ranging devices may include an aiming system using, e.g. gyroscopic systems, computer vision or other technologies. In some embodiments of the invention, a radar ranging device that employs electromagnetic waves may be used. Alternatively, sonar or other acoustic ranging devices may be used in some embodiments of the invention as they may be more applicable for certain environments, e.g. underwater vehicles. Based on the sensed conditions, events or changes in the environment may be detected.

Communication system 225 may include a local wireless communication ink with neighboring vehicles, along with GPS Synchronized Precision Time Protocol supported by GPS 235. The GPS clock may be extracted and suppled from GPS 235. In accordance with various embodiments of the invention, the communication system may use a digital radio, such as WiFi, Bluetooth, ZigBee, PTP/IEEE-1588, and IEEE 802.11p. Other embodiments may use analog radio options enabling, for example, software radio implementations. Optical or acoustic, e.g. sonar, communication inks may be preferable for underwater vehicles. Controller 230 can take various inputs and produce a control signal to regulate the interspacing distance.

While not illustrated in FIG. 2, each vehicle may include an electrohydraulic braking and throttle actuation system that responds to an applied signal, e.g., derived from the received control signal. For example, in some embodiments, the electrohydraulic braking systems may include a BRAKEMATIC produced by EMG Automation GmbH. In addition, various embodiments may employ throttle control systems such as are used in cruise control systems. An interface to electronic braking systems, such as those produced by TRW Automotive or the MOVE gateway produced by TNO can be used in various embodiments.

An onboard computer may be used in some embodiments, e.g., to implement processor(s) 215 and/or controller 230. For example, a Field Programmable Gate Array (FPGS) such as the Xiinx Zynq-7000 All Programmable System on a Chip may be used in some embodiments. Alternatively, various schemes for embedded processing can be used, such as ABBs System 800xA or the AC 800M processor module 3. A dSpace Autobox system can be used in one or more embodiments. Alternatively, the system can be implemented using standard computing technologies, such as a laptop or other personal computer that has the necessary interfaces for data acquisition and transmission and an appropriate software platform such as MATLAB. The functionality of processor(s) 215 and controller 230 may be combined or divided in any manner chose by the implementor.

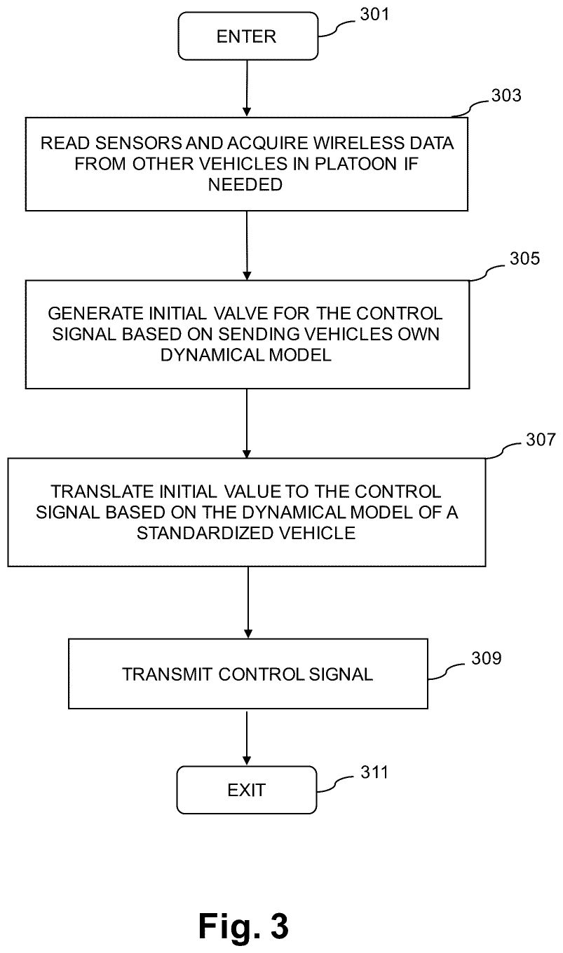

FIG. 3 shows an illustrative process inflow chart form for use in generating a control signal in a sending vehicle of a platoon that is using a CACC-type control method, the control signal being for use in controlling the action of at least one of the brake and throttle of at least one other vehicle of the platoon, wherein the control signal is represented with respect to a dynamical model of a standardized vehicle in accordance with the principles of the invention, and the receiving vehicle applies its brakes or throttle based on the received control signal. More specifically, in accordance with an aspect of the invention, the control signal transmitted is with respect to a model of a standardized vehicle. In accordance with an aspect of the invention, the model of a standardized vehicle may represent a dynamical model of a “standardized model” vehicle. Such a “model” vehicle need not be for any vehicle in actually the platoon or and it may be a virtual model in that it need not correspond to any actually existing vehicle. In accordance with an embodiment of the invention, the model of a standardized vehicle may be of a “model” vehicle that has a mass of 100 kg. and a one second time constant of the first order linear dynamical system modeling the hydraulic actuators of the “model” vehicle for both the brake and the throttle.

The process is entered in step 301 when it is time to generate the next value of the control signal. Such is usually on a predefined scheduled controlled by a clock. For example, the process may be performed 50 times per second to achieve accurate platoon control. The process is initially performed upon the vehicle becoming part of the platoon. Entering into the platoon is well known in the art. The control signal is typically sent to a receiving vehicle which is its subsequent vehicle in the platoon.

Next, in step 303, the values of the sensors of the sending vehicle are read and wireless data from any other vehicle of the platoon that is necessary is obtained. For example, with regard to sensors, the speedometer, the ranging sensors, and a sensor for detecting its own operating mass, which is part of the vehicular data, may be obtained. Also, the sending vehicle may receive a control signal, e.g., from its own predecessor vehicle. In the event that the sending vehicle is the first vehicle of the platoon, it may not receive any control signal.

Thereafter, in step 305, the sending vehicle generates an initial value for the control signal based on the sending vehicle's own dynamical model. In other words, the sending vehicle assumes that the receiving vehicle has a dynamical model identical to itself and uses when developing the initial value of the control signal.

In accordance with an aspect of the invention, the sending vehicle translates each initial value into a corresponding value for the standardized vehicle dynamical model in step 307. Thus, the control signal as sent represents the equivalent control action as was developed for the sending vehicle based on its own dynamical model but when effectuated on the standardized vehicle. The dynamical model of the standardized vehicle is known, or made available, to at least the vehicle sending the control signal and the vehicle receiving the control signal and in some embodiments of the invention to all of the vehicles of the platoon, preferably before automated control begins. This may be achieved, for example, by having the dynamical model of the standardized vehicle be prestored in each vehicle or it may be exchanged via wireless communication, e.g., upon platoon formation.

In accordance with an aspect of the invention, the model of a standardized vehicle may represent a dynamical model of a “standardized model” vehicle. Such a “model” vehicle need not be for any vehicle in actually the platoon or and it may be a virtual model in that it need not correspond to any actually existing vehicle. In accordance with an embodiment of the invention, the model of a standardized vehicle may be of a “model” vehicle that has a mass of 100 kg. and a one second time constant of the first order linear dynamical system modeling the hydraulic actuators of the “model” vehicle for both the brake and the throttle.

In accordance with an aspect of the invention, the control signal may be represented a unified numerical signal that is a number and, based on the value of the number, specifies the brake or throttle to be applied. For example, in one embodiment of the invention, each value of the control signal may range from between 100 and +100, where −100 indicates to apply full brake and +100 indicates to apply full throttle.

Lastly, in step 309, the sending vehicle transmits the translated initial value as the control signal. The process then exits in step 311.

In an embodiment of the invention, the control action to be taken at the receiving vehicle may be computed onboard the sending vehicle based not only on the developed control signal with respect to the dynamical model of the standardized vehicle but also on a distance between the receiving vehicle and the sending vehicle and this control action is transmitted as the control signal.

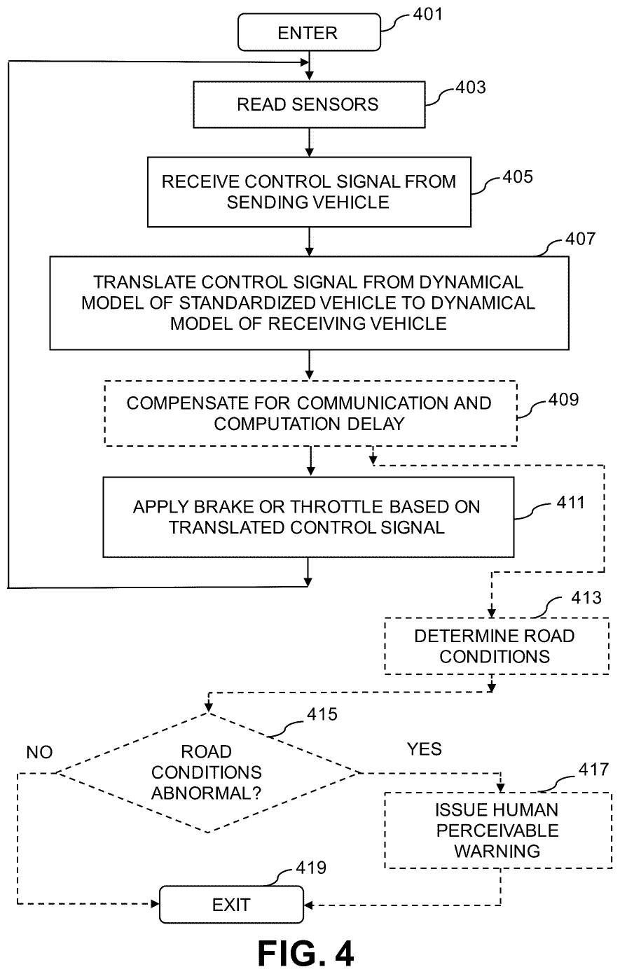

FIG. 4 shows an illustrative process inflow chart form for using a control signal received at a vehicle of a platoon that is using a CACC-type control method where the control signal is used to control the action of at least one of the brake and throttle of the receiving vehicle where the control signal is represented with respect to a model of a standardized vehicle, e.g., the above mentioned model, and the receiving vehicle applies its brakes or throttle based on the received control signal. More specifically, in accordance an aspect of the invention the control signal received is with respect to a model of a standardized vehicle.

The process is entered in step 401 when it is time to generate the next value of the control signal. Such is usually on a predefined scheduled controlled by a clock. For example, the process may be performed 50 times per second to achieve accurate platoon control. The process is initially performed upon the vehicle becoming part of the platoon. Entering into the platoon is well known in the art. The control signal is typically sent to a receiving vehicle which is its subsequent vehicle in the platoon.

Next, in step 403, the values of the sensors of the receiving vehicle are read. For example, with regard to sensors, the speedometer, the ranging sensors, and a sensor for detecting its own operating mass, which is part of the vehicular data, may be obtained.

Thereafter, in step 405, the control signal from the sending vehicle is received. In accordance with an aspect of the invention, the control signal as received is with respect to a model of a standardized vehicle.

In accordance with an aspect of the invention, the receiving vehicle translates each value of the received control signal, which is represented with respect to a standard vehicle model, into a value into a corresponding value for the dynamical model of the receiving vehicle. Thus, the control signal as received represents an action as when effectuated on the standardized dynamical vehicle and the translated version thereof represents the same action but when effectuated on the dynamical model of the receiving vehicle.

Next, in accordance with an aspect of the invention, in optional step 409, compensation for the delay related to communication and processing with regard to the control signal may be applied to the translated control signal. Note that in principle the compensation may be applied to the control signal prior to translation.

In step 411, action is taken by the receiving vehicle to apply its brakes or throttle based on the received control signal. In this regard, note that, in accordance with an embodiment of the invention, the action taken at the vehicle receiving the control signal is based not only on the translated received control signal, which may be a compensated version thereof, but also on a determined distance between the receiving vehicle and the transmitting vehicle thereby taking into account the actual distance between the transmitting vehicle and the receiving vehicle. Doing so may facilitate maintaining a desired distance between the receiving vehicle and the transmitting vehicle

Advantageously, the platoon may be a heterogeneous platoon and each vehicle in the platoon can have its brake and throttle property controlled without needing to know anything about the dynamical model of any vehicle in the platoon other than its own.

In optional step 413 the road conditions are determined. Conditional branch point 415 tests to determine if the road conditions are considered to be abnormal. If the test result in step 415 is YES, control passes to step 417 in which a human perceivable warning is issued. Such a warning enables a human backup driver to take an action such as manually applying the brakes so as to slow or stop the vehicle in a safe manner. If the test result in step 415 is NO, control passes to step 419 and the process is exited.

In accordance with an aspect of the invention, as indicated hereinabove, road conditions can be determined, whether are not such road conditions are abnormal can be ascertained, and if the road conditions are abnormal, a human perceivable warning can be issued to an attendant in the vehicle. Such was described at a high level hereinabove in conjunction with FIG. 4, e.g., steps 413, 415, and 417. A more detailed explanation shall now be set forth. More specifically, as part of step 413, real time values of residuals are developed.

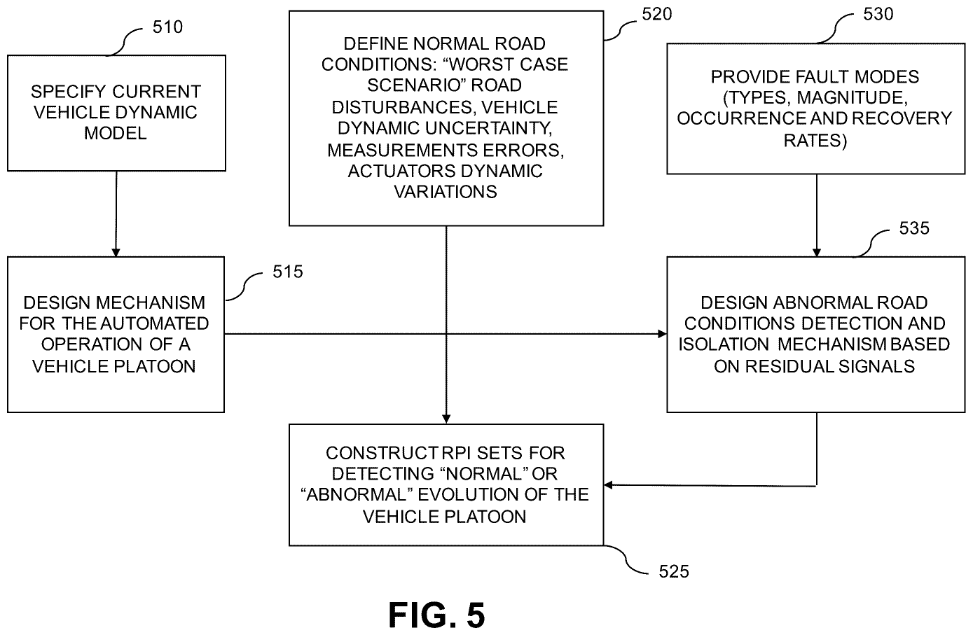

To this end, FIG. 5 shows an illustrative process in flow chart form of the “offline”, i.e., design stages of a mechanism for detecting abnormal road conditions for a platoon of vehicles, in accordance with an aspect of the invention. Note that the “offline” steps are separate from the “online” steps which are the computations that are done in the various vehicles of the platoon, e.g., as described above and also further hereinbelow.

Steps 510, 520 and 530 respectively contain the modeling, decision and observation elements. At step 510 the dynamical model of each vehicle is specified based on analysis of information about the vehicles which is acquired, e.g., from the manufacturer's technical specifications. At step 520 certain parameters pertaining to measurement noise specific to the ranging sensors, the amplitude of road disturbances, and model uncertainty or parametric uncertainty bounds for vehicle's dynamical models are defined. In particular, the definition of “normal” road conditions may be done as described in paragraphs [0031] and [0032]. At step 530 hardware fault models, types, and magnitude or magnitude bounds, are provided. These steps serve as preliminary steps that are used in step 515 to design the longitudinal control arrangement for operating the platoon in an automated manner.

Steps 515 and 530 are prerequisite steps for the design of the process to detect abnormal road conditions performed in step 535. The process of detecting abnormal road conditions should be able to aggregate measurable and/or reference signals from the vehicle platoon in order to develop the residual signals. When the properties of the longitudinal control arrangement for operating the platoon is combined with the properties of the abnormal road conditions detection process, the closed loop evolution of the platoon under normal, e.g., healthy, functioning conditions becomes distinguishable from the operation under abnormal, e.g., faulty, functioning conditions. Specifically, it becomes possible to assess the possible values of the residual signals under either healthy or under faulty modes and to bound them into the associated residual sets, such as are constructed at step 525. Such bounded sets may be robust positively invariant (RPI) sets which are bounded subsets or regions of the state space of a dynamical model. Note that such techniques can be employed to simplify or improve the online stage. In particular, describing the sets through set-invariance concepts at step 525 allows the providing of invariant, unchanging shapes which permit an a priori analysis of undetected “abnormal” road conditions and an analysis of false alarms for abnormal road conditions by checking set intersections and thereby, advantageously, reduce the time of the computations performed during the operation of the platoon because the needed sets not be recomputed at each step.

A more in depth description of methods for the development of the control signal and of the control action in terms of the standard reference model, in accordance with the principles of the invention, is provided next Towards this description, some notation conventions must be introduced. The used notation is fairly standard in control systems. The Laplace transform complex variable is denoted by s∈ [symbol] , while the Z transform complex variable is denoted by s∈ [symbol] , in order to distinguish it from the notation employed for the vehicles inter-spacing errors. The Laplace transform of a given real signal u(t) will be denoted with u(s) and can be distinguished by the change in the argument. The Z transform of a given discrete time signal u[t] will be denoted with u(s). When the time argument (t) or the frequency argument (s) can be inferred from the context it will be omitted for brevity. The derivative with respect to the time variable t of [symbol] (t) is denoted with [symbol] (t). The following notation is employed:
a [symbol] b a is by definition equal to b
[symbol] (s) Set of all real-rational transfer functions in the Laplace domain.
[symbol] (z) Set of all real-rational transfer functions in the Z domain.
[symbol] (s)^{p×q} Set of p×q matrices having all entries in [symbol] (s)
[symbol] (z)^{p×q} Set of p×q matrices having all entries in [symbol] (z)
LTI Linear and Time Invariant
TFM Transfer Function Matrix
Qᵢⱼ The i-th row, j-th column entry of TFM Q
G*u(t) The time response (with zero initial conditions) of the dynamical system G with an input u(t)
T_{z}_{ᵢ}_{w}_{ⱼ} The i-th row, j-th column entry of the TFM T_{zw}∈ [symbol] (s)^{p×q}, mapping input vector w to output vector z

We use the following notation for diagonal matrices:

$$D \{ {d}_{1} , {d}_{2} , … , {d}_{n} \} {=}^{def} [ \begin{matrix}{d}_{1} & 0 & 0 & … & 0 \\ 0 & {d}_{2} & 0 & … & 0 \\ 0 & 0 & {d}_{3} & … & 0 \\ ⋮ & ⋮ & ⋮ & ⋱ & ⋮ \\ 0 & 0 & 0 & … & {d}_{n}\end{matrix} ]$$

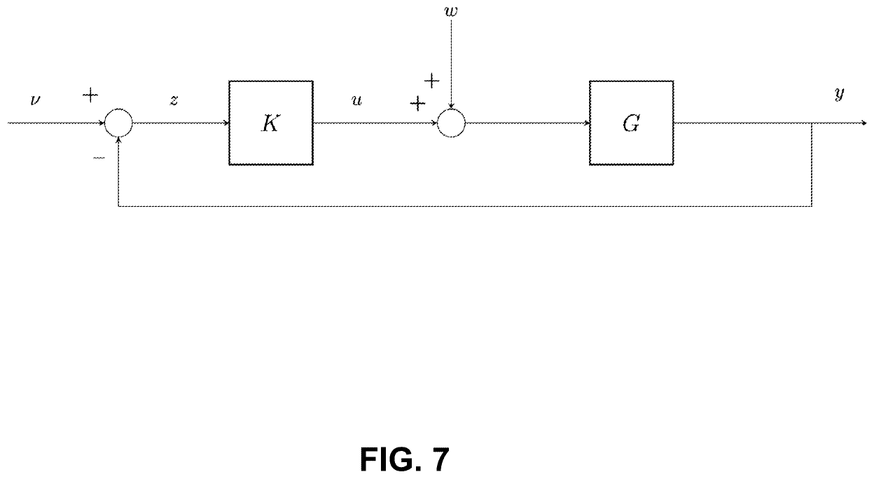

Turning now to FIG. 7, the systems shown therein belongs to classical framework in control engineering as it represents the standard unity feedback configuration of the plant G with the controller K where G is a multivariable (strictly proper) LTI plant and K is an LTI controller. In FIG. 7, w and v represent the input disturbance and sensor noise, respectively and u and z are the controls and measurements vectors, respectively. In the framework of the invention, the plant G is related to the vehicles platoon, as described below. Denote by

$$H ( G , K ) = [ \begin{matrix}{T}_{z w} & {T}_{z ν} \\ {T}_{u w} & {T}_{u ν}\end{matrix} ] {=}^{def} [ \begin{matrix}- {( I + GK )}^{- l} G & {( I + GK )}^{- 1} \\ - {K ( I + GK )}^{- 1} G & {K ( I + GK )}^{- 1}\end{matrix} ] \qquad ( 1 )$$

the closed-loop TFM of FIG. 7 from the exogenous signals [w^{T} v^{T}]^{T} to [z^{T} u^{T}]T. We say a certain continuous time system's TFM is stable if it has all its poles in the open left complex half-plane. We say a certain discrete time system's TFM is stable if it has all its poles inside the unit circle. A TFM is called unimodular if it is square, proper, stable, and has a stable inverse. If H(G, K) is stable, we say that K is a stabilizing controller of G, or equivalently that K stabilizes G.

Given a square plant G∈ [symbol] (s)^{n×n} from FIG. 7, a right coprime factorization of G is a fractional representation of the form G=NM⁻¹ with both factors N, M∈ [symbol] (s)^{n×n} being stable and for which there exist X, Y∈ [symbol] (s)^{n×n} that are also stable, satisfying YM+XN=Iₙ, with Iₙ being the identity matrix. Analogously, a left coprime factorization of G is defined by G=\tilde{M}⁻¹Ñ, with Ñ, \tilde{M}∈ [symbol] (s)^{n×n} both stable and satisfying \tilde{M}\tilde{Y}+Ñ\tilde{X}=Iₙ, for certain stable TFMs \tilde{X}, \tilde{Y}∈ [symbol] (s)^{n×n}. A collection of eight stable TFMs (M, N, \tilde{M}, Ñ, X, Y, \tilde{X}, \tilde{Y}) is called a doubly coprime factorization of G if \tilde{M} and M are invertible, yield the factorizations G=\tilde{M}⁻¹Ñ=NM⁻¹, and satisfy the following equality (Bézouts identity):

$$[ \begin{matrix}- \tilde{N} & \tilde{M} \\ Y & X\end{matrix} ] [ \begin{matrix}- \tilde{X} & M \\ \tilde{Y} & N\end{matrix} ] = {I}_{2 n} . \qquad ( 2 )$$

Doubly coprime factorizations with respect to the unit circle for discrete time LTI systems may be defined accordingly.

Let (M, N, \tilde{M}, Ñ, X, Y, \tilde{X}, \tilde{Y}) be a doubly coprime factorization of G. Any controller K_{Q} stabilizing the plant G, in the feedback interconnection of FIG. 7, can be written as

K_{Q}=Y_{Q}⁻¹X_{Q}=\tilde{X}_{Q}\tilde{Y}_{Q}⁻¹, (3)

where X_{Q}, \tilde{X}_{Q}, Y_{Q} and \tilde{Y}_{Q} are defined as:

X_{Q} [symbol] X+Q\tilde{M}, \tilde{X}_{Q} [symbol] \tilde{X}+MQ, Y_{Q} [symbol] Y−QÑ, \tilde{Y}_{Q} [symbol] \tilde{Y}−NQ (4)

for some stable Q in [symbol] (s)^{n×n}. It also holds that K_{Q} from (3) stabilizes G, for any stable Q in [symbol] (s)^{n×n}. Starting from any doubly coprime factorization (2), the following identity

$$[ \begin{matrix}- \tilde{N} & \tilde{M} \\ {Y}_{Q} & {X}_{Q}\end{matrix} ] [ \begin{matrix}- {\tilde{X}}_{Q} & M \\ {\tilde{Y}}_{Q} & N\end{matrix} ] = {I}_{2 n} . \qquad ( 5 )$$

provides an alternative doubly coprime factorization of G, for any stable Q∈ [symbol] (s)^{n×n}.

The platoon contains one leader vehicle and n∈ [symbol] follower vehicles traveling along a roadway, in the same, positive direction of an axis with origin at the starting point of the leader. Henceforth, the “0” index will be reserved for the leader. We denote by [symbol] ₀(t) the time evolution of the position of the leader vehicle, which can be regarded as the “reference” for the entire platoon. The dynamical model for the k-th vehicle in the string, (0≤k≤n) may described by its corresponding LTI, continuous-time, finite dimensional transfer function Gₖ(s) from its control signal uₖ(t) to its position [symbol] ₖ(t) on the roadway. While in motion, the k-th vehicle may be affected by the road disturbance wₖ(t), which is additive to the control input uₖ(t), specifically

[symbol]

ₖ(t)=Gₖ*(wₖ(t)+uₖ(t)).

The control action u₀(t) of the leader vehicle is not assumed to be automatically generated as it may be generated by a human operator. The leader vehicle does not transmit any data or information to any other vehicle in the platoon.

The goal is for every vehicle in the platoon to follow the leader while maintaining a certain inter-vehicle spacing distance which is denoted with Δ. If the inter-vehicle spacing policy is assumed to be constant, then Δ is given as a pre-specified positive constant Under the assumption that Δ is content and under the assumption that the platoon starts from the initial desired formation ( [symbol] ₖ(0)=−kΔ, for 0≤k≤n), the time evolution for the position of each vehicle becomes:

[symbol]

ₖ(t)=Gₖ*(uₖ(t)+wₖ(t))−kΔ, for 0≤k≤n. (6)

The inter-spacing error between the k-th vehicle and its predecessor, the (k−1)-th vehicle is denoted with zₖ(t) and is defined as

zₖ(t) [symbol] [symbol] ₖ₋₁(t)− [symbol] ₖ(t)−Δ, for 1≤k≤n. (7)

There is no loss of generality in assuming that Δ=0 in equation (6) or in considering vehicles with different lengths, since these parameters can be “absorbed” in the spacing error signals (7). These assumptions are common in the prior art and they do not alter the subsequent analysis.

In an illustrative embodiment an inter-vehicle spacing policy that is proportional with the vehicle's speed [symbol] k(t), known as time headway, may be implemented. For a constant time headway h>0 the expression of the spacing errors becomes

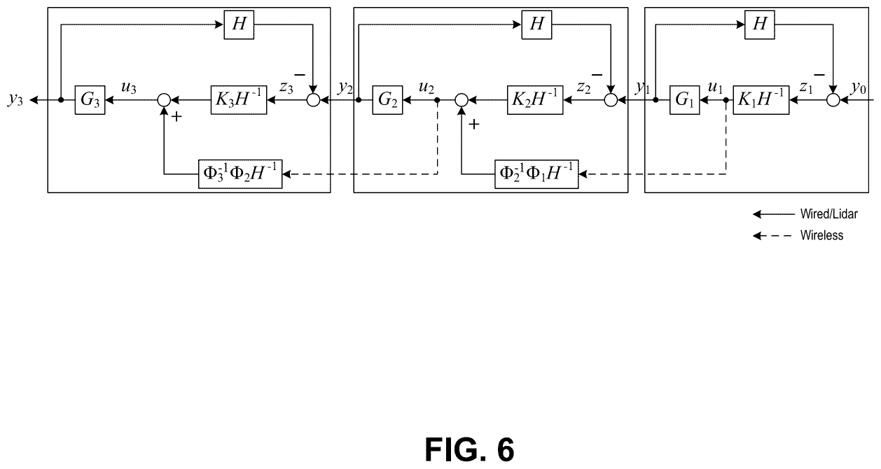

zₖ(t) [symbol] [symbol] ₖ₋₁(t)−( [symbol] ₖ(t)+h [symbol] ₖ(t)), (8)

where [symbol] ₖ(t) is the speed of the k-th vehicle. Note that for h=0 in (8) the time-headway becomes the constant vehicle inter-spacing policy (7). Turning now to FIG. 6, under “zero” error initial conditions the vehicle inter-spacing errors can be written as:

zₖ₊₁=Gₖ*(uₖ+wₖ)−HGₖ₊₁*(uₖ₊₁+wₖ₊₁), 0≤k≤(n−1), (9)

where

$${H}^{- 1} ( s ) {=}^{def} \frac{1}{hs + 1} , h > 0 \qquad ( 10 )$$

is the inverse of the transfer function of the time-headway. The following notation for the aggregated signals of the platoon will be used:

$$z {=}^{def} {[ \begin{matrix}{z}_{1} & {z}_{2} & … & {z}_{n}\end{matrix} ]}^{T} , w {=}^{def} {[ \begin{matrix}{w}_{1} & {w}_{2} & … & {w}_{n}\end{matrix} ]}^{T} , \qquad ( 11 )$$

$$u {=}^{def} {[ \begin{matrix}{u}_{1} & {u}_{2} & … & {u}_{n}\end{matrix} ]}^{T} .$$

Define T∈ [symbol] (s)^{n×n} as

$$T {=}^{def} [ \begin{matrix}H & O & O & … & O \\ - 1 & H & O & … & O \\ O & - 1 & H & … & O \\ ⋮ & ⋮ & ⋮ & & ⋮ \\ O & O & O & … & H\end{matrix} ] . \qquad ( 12 )$$

Let

G [symbol] T [symbol] {G₁,G₂, . . . ,Gₙ} (13)

denote the aggregated TFM of the platoon, from the vector u of the control signals of the vehicles in the platoon, with the exception of the leader vehicle, to the inter-spacing error signals vector z. G will be referred to as the platoon's plant, since in the classical control systems framework, it relates the control signals with the regulated measurements. The evolution of the vehicle inter-spacing distances becomes:

z=V₁G₀*(u₀+w₀)−G*(u+w), (14)

where V₁ [symbol] [1 0 . . . 0]^{T} is the first column vector of the Euclidian basis in [symbol] . Turning now to FIG. 6, a description of the first three vehicles in the platoon is provided, e.g. vehicles 100A, 110B and 110C in FIG. 1. The dynamical system representing the k-th vehicle is described by its input/output operator Gₖ from the control signal uₖ(t) to its position [symbol] ₖ(t) on the roadway, where 1≤k≤3. The inter-vehicle spacing errors, denoted with z₁, z₂ and z₃ and defined in (8), can be measured on board of the first, the second and the third vehicle, respectively using for instance forward mounted ranging sensors.

Turning now to FIG. 5, in an illustrative embodiment of the invention, the vehicle's dynamical model may be represented in accordance to step 510 by a second order LTI system with damping or as a double integrator with first order actuator dynamics. The dynamical model Gₖ for vehicle k, with 0≤k≤n, may be given by a strictly proper transfer function [symbol] (s)∈ [symbol] (s) weighted by a unimodular factor Φₖ∈ [symbol] (s), such as:

Gₖ [symbol] Φₖ [symbol] (15)

The following notation is used for the n×n diagonal unimodular TFM:

Φ [symbol] [symbol] {Φ₁, . . . ,Φₙ}. (16)

The expression of the platoon's plant therefore becomes G=TΦ [symbol] .

Also, in accordance to step 510 from FIG. 5, in an illustrative embodiment, for a point-mass model including a double integrator with a first order actuator ( [symbol] ₖ>0),

$${G}_{k} ( s ) = \frac{s + {σ}_{k}}{{m}_{k} {s}^{2} ( {τ}_{k} s + 1 )} , for 1 \leq k \leq n , \qquad ( 17 )$$

and so it follows that [symbol] is the double integrator 1/s² and Φₖ equals to

$$\frac{s + {σ}_{k}}{{m}_{k} ( {τ}_{k} s + 1 )}$$

with [symbol] ₖ>0, where mₖ and τₖ are the mass and the brake and throttle actuator time constant respectively, of the k-th vehicle. This allows to model the different masses and the different actuating time constants corresponding to different types vehicles in the platoon, e.g. trucks versus automobiles. In an illustrative embodiment of the invention, rational Padě approximations of [symbol] time-delays may be included in the expression of [symbol] .

A doubly coprime factorization ( [symbol] , [symbol] , [symbol] , [symbol] , [symbol] , [symbol] , [symbol] , [symbol] ) of [symbol] may be computed using standard methods of the prior art, with [symbol] and [symbol] strictly proper. Then there exists a doubly coprime factorization (2) of G, denoted (M, N, \tilde{M}, Ñ, X, Y, \tilde{X}, \tilde{Y}), and having the following expression:

$$[ \begin{matrix}- \tilde{N} & \tilde{M} \\ Y & X\end{matrix} ] {=}^{def} [ \begin{matrix}- T Φ & {I}_{n} \\ {H}^{- 1} T Φ & {H}^{- 1} {I}_{n}\end{matrix} ] , \qquad ( 18 a )$$

$$[ \begin{matrix}- \tilde{X} & M \\ \tilde{Y} & N\end{matrix} ] {=}^{def} [ \begin{matrix}- {Φ}^{- 1} {T}^{- 1} & {Φ}^{- 1} {T}^{- 1} H \\ {I}_{n} & H {I}_{n}\end{matrix} ] ; \qquad ( 18 b )$$

Turning now to FIG. 7, by choosing the Youla parameter to be diagonal in the doubly coprime factorization of (18), the following left factorization of the controller K stabilizing the platoon's plant may be obtained:

$${Y}_{Q} = [ \text{} \begin{matrix}( - {Q}_{11} H ) {Φ}_{1} & O & ⋯ & O \\ ( - {H}^{- 1} + {Q}_{22} ) {Φ}_{1} & ( - {Q}_{22} H ) {Φ}_{2} & ⋯ & O \\ O & ( - {H}^{- 1} + {Q}_{33} ) {Φ}_{2} & ⋯ & O \\ ⋮ & ⋮ & ⋮ & ⋮ \\ O & O & ⋯ & \begin{matrix}( - \\ {Q}_{mn} H ) {Φ}_{n}\end{matrix}\end{matrix} ] \text{} , \qquad ( 19 a )$$

$${X}_{Q} = [ \begin{matrix}( {H}^{- 1} + {Q}_{11} ) & O & ⋯ & O \\ O & ( {H}^{- 1} + {Q}_{22} ) & ⋯ & O \\ O & O & ⋯ & O \\ ⋮ & ⋮ & ⋮ & ⋮ \\ O & O & ⋯ & \begin{matrix}( {H}^{- 1} + \\ {Q}_{nm} )\end{matrix}\end{matrix} ] . \qquad ( 19 b )$$

Turning now to FIG. 6 and the systems shown therein, the left factorization from (19) may be used in order to obtain the expression of the control actions of the vehicles in the platoon, via the following description of the Kₖ systems shown in FIG. 6, where 1≤k≤n:

u=H⁻¹Φ_{ldiag}*u+H⁻¹K*z, (20)

where

$${Φ}_{ldiag} {=}^{def} [ \begin{matrix}O & O & O & ⋯ & O & O \\ {Φ}_{2}^{- 1} {Φ}_{1} & O & O & ⋯ & O & O \\ O & {Φ}_{3}^{- 1} {Φ}_{2} & O & ⋯ & O & O \\ O & O & {Φ}_{4}^{- 1} {Φ}_{3} & ⋯ & O & O \\ ⋮ & ⋮ & ⋮ & ⋱ & ⋮ & ⋮ \\ O & O & O & ⋯ & {Φ}_{n}^{- 1} {Φ}_{n - 1} & O\end{matrix} ] , \qquad ( 21 )$$

$$K {=}^{def} \{ {K}_{1} , {K}_{2} , ... , {K}_{n} \} , \qquad ( 22 )$$

$${K}_{k} {=}^{def} {{Φ}_{k}^{- 1} ( - {Q}_{kk} H )}^{- 1} ( + {Q}_{kk} H ) ,$$

where Kₖ∈ [symbol] (s), for any 1≤k≤n.

More specifically, the systems shown in FIG. 6 provide the following description on developing the uₖ control action on board the k-th vehicle, with k=2 and k=3:

uₖ=H⁻¹Φₖ⁻¹Φₖ₋₁*uₖ₋₁+Kₖ*zₖ (23)

Note that (23) is in fact the k-th block-row component, corresponding to the k-th vehicle, of equation (20), written for the entire platoon. Turning now to FIG. 4, the ranging sensors of the k-th vehicle acquire the zₖ vehicle inter-spacing distances in real time in accordance to step 403, at the same time the control signal uₖ₋₁ is received on board the k-th vehicle in accordance to step 405 e.g. from the preceding vehicle. At step 411, the brake and throttle action may be developed on board the k-th vehicle in accordance to (23).

Turning now to FIG. 5, in accordance to step 515, prior art methods, such as robust controller design using normalized coprime factors plant descriptions may be used for finding in (19) the Youla parameter that will result in the controllers K from FIG. 7 that are robust to uncertainty in the vehicle's dynamical models Gₖ which make up the platoon's plant G. In certain embodiments, controller design methods for dealing with polytopic parametric uncertainties in the vehicle's dynamical model Gₖ may be used, such as polytopic uncertainties on the time constant τₖ of the actuator at the k-th vehicle.

Turning now to FIG. 6, a representation of the first three vehicles in the platoon is provided, e.g. vehicles 110A, 110B and 110C in FIG. 1. The arrangement for any two consecutive vehicles in the platoon, such as the k−1 and the k vehicle with 2≤k≤n can be retrieved accordingly from FIG. 6 by taking k=2 or k=3. The corresponding K, Φ and H⁻¹ blocks may be implemented by means of digital filters using for example discretization methods applied to their corresponding continuous time models defined above. In FIG. 6, the zₖ signals correspond to the measured inter-spacing distances between the k-th vehicle and its predecessor in the platoon, which can me measured on board the k-th vehicle using, for instance, a forward mounted ranging sensor, while the uₖ signals correspond to the control action developed on board the k-th vehicle, which may be fed into its brake and throttle actuators. In certain embodiments the dynamical model of the vehicle may have one expression for the throttling action and another distinct expression for the braking action, resulting in a model known as a switched system in the prior art.

In certain embodiments of the invention, equivalent arrangements to the one in FIG. 6 can be obtained, for example, by placing on board the second vehicle the K₃H⁻¹ and Φ₃⁻¹Φ₂H⁻¹ filters from the third vehicle and equipping the second vehicle with a rear facing ranging sensor capable of measuring the z₃ inter-spacing distance in real time.

In the arrangement of FIG. 6 it may be necessary for the k-th vehicle to have available on board information about the dynamical model of the preceding vehicle, namely the (k−1)-th vehicle. Such information may include the description of the Φₖ₋₁ system, which is needed in order to perform on board the k-th vehicle the filtration of the received uₖ₋₁ signal. Next is described an arrangement where it is not necessary for any vehicle in the platoon to transmit or make available to any other vehicle in the platoon details pertaining to its own dynamical model, in accordance with the principles of the invention.

Turning now to FIG. 5, in accordance to step 510, in certain embodiments, a point-mass model comprised of the double integrator with a first order actuator (τₖ>0), which is common in the prior art, may be used:

$${G}_{k} ( s ) = \frac{1}{{m}_{k} {s}^{2} ( {τ}_{k} s + 1 )} , for 1 \leq k \leq n , \qquad ( 24 )$$

The vehicle model from (24) may be used conjunction with specialized electro-hydraulic brake and throttle actuator, actuator interfaces and/or gateways can translate the actuator's setpoints into a vehicle's acceleration setpoints. In certain embodiments, a pre-compensating causal, unimodular filter

$$\frac{s + {σ}_{k}}{s + {σ}_{0}}$$

may be used in cascade with the vehicle's specialized electro-hydraulic brake and throttle actuators, actuator interfaces, or brake and throttle by wire. The filter may have a stable Smith zero at −σₖ, specific to the k-th vehicle and a stable pole at −σ₀, which may be taken to be the same for al vehicles in the platoon. In certain embodiments the model of the k-th vehicle along with the pre-compensating filter may thus be taken equal to:

$${G}_{k} ( s ) = \frac{s + {σ}_{k}}{{m}_{k} ( s + {σ}_{0} ) {s}^{2} ( {τ}_{k} s + 1 )} , for 1 \leq j \leq n , \qquad ( 25 )$$

In certain embodiments the [symbol] TFM from (15) may be of the form

$$\frac{1}{{s}^{2} ( s + {σ}_{0} )}$$

and the TFM Φₖ may be of the form

$$\frac{s + {σ}_{k}}{{m}_{k} ( {τ}_{k} s + 1 )}$$

with σₖ>0 and mₖ and [symbol] ₖ being the mass and actuator time constant respectively, specific to the k-th vehicle. In the aforementioned embodiments, the [symbol] TFM from (15) may be considered the standardized vehicle dynamical model.

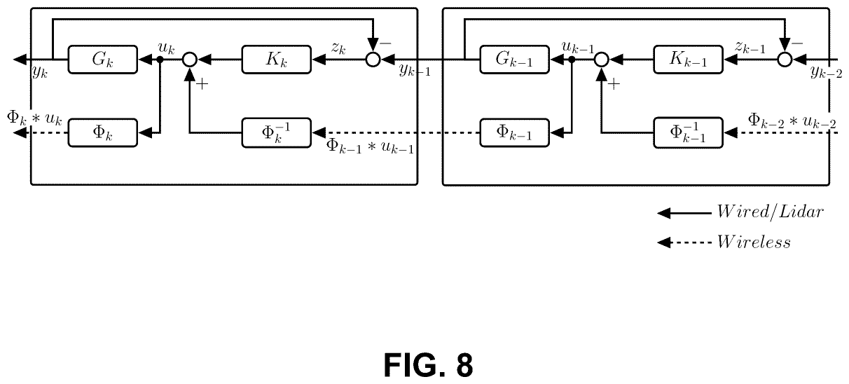

Turning now to FIG. 8, it describes two consecutive vehicles in the platoon, e.g. vehicles 110C and 110D in FIG. 1. Note that Φₖ is unimodular, therefore the filtration of the control signal uₖ with Φₖ may be performed on board the k-th vehicle before the transmission to the (k+1) vehicle. After the filtration of uₖ is received on board the following vehicle, e.g. the (k+1) vehicle, it only remains to perform a filtration through the Φₖ₊₁⁻¹ factor on board the (k+1) vehicle. Therefore the (k+1) vehicle does not need to know the Φₖ factor. In this arrangement, the [symbol] factor from (15) is taken to be the standardized vehicle dynamical model vehicle, described herein above.

Turning now to FIG. 3, in accordance to step 303 the zₖ inter-vehicle spacing distance is acquired on board the k-th vehicle, at the same time the Φₖ₋₁*uₖ₋₁ signal is received from the preceding vehicle, in a translated form based on the standardized vehicle dynamical model. In accordance to step 305, an initial value for the control signal uₖ at the k-th vehicle will be generated via a filtration with Φₖ⁻¹, based on the k-th vehicle own dynamical model of the Φₖ₋₁*uₖ₋₁ signal. This may also be considered to be the operation performed at step 407 of FIG. 4. The control signal uₖ is fed in the brake and throttle actuator of the k-th vehicle, in accordance with step 411, also from FIG. 4. Next, in accordance to step 307, the control signal uₖ is translated to a control signal based on the standardized vehicle dynamical model, via a filtration with Φₖ, before being transmitted to the (k+1)-th vehicle.

Also in FIG. 3, if G_{model} is considered to denote the standardized vehicle dynamical model, then in accordance to step 305 on board the (k−1)-th vehicle, a filtration is performed on the control signal received from the (k−2)-th vehicle, with G_{model}Gₖ₋₁⁻¹. This operation may be also be used to implement step 407 from FIG. 4. Turning back to FIG. 3, also on board the (k−1)-th, a filtration with G_{model}⁻¹Gₖ₋₁ is performed on the control action uₖ₋₁ before being transmitted to the k-th vehicle in the platoon, in accordance to step 307. Similarly, on board the k-th vehicle a filtration is performed with G_{model}Gₖ⁻¹ on the control signal received from the (k−1)-th vehicle in accordance to step 305. Also on board the k-th, a filtration with G_{model}⁻¹Gₖ is performed on the control action uₖ before it is transmitted to the (k+1)-th vehicle in the platoon, in accordance to step 307.

A more in depth description of the abnormal road conditions detection mechanism is provided next. For the methods and systems described here, the consideration of discrete-time systems is more suitable. Nonetheless, continuous-time systems equivalent counterparts of described arrangements and systems may exist and will become apparent to those skilled in the art.

Note that by plugging the time evolution (6) written for the k-th and (k−1)-th vehicle respectively, into (7), the expression of the k-th vehicle inter-spacing error signal reads:

zₖ [symbol] [symbol] ₖ₋₁− [symbol] ₖ= [symbol] Φₖ(Φₖ⁻¹Φₖ₋₁uₖ₋₁−uₖ)+ [symbol] Φₖ⁻¹wₖ₋₁− [symbol] Φₖwₖ (26)

In certain embodiments of the invention, the definition of the vehicle inter-spacing distances may include a component proportional with a speed of the vehicle, known as time headway in the prior art One such example of time headway can be implemented in the vehicle inter-spacing error zₖ[t], which becomes:

zₖ[t] [symbol] [symbol] ₖ₋₁[t]−( [symbol] ₖ[t]+h( [symbol] ₖ[t]− [symbol] ₖ[t−1])), for 1≤k≤n, (27)

or equivalently, by employing the expression from (6):

zₖ=Gₖ₋₁*(uₖ₋₁+wₖ₋₁)−HGₖ*(uₖ+wₖ), 1≤k≤n. (28)

Turning now to FIG. 6, the discrete-time filter H(λ) [symbol] 1+h (1+λ⁻¹), with h>0 which can also be written as:

$$H ( λ ) = \frac{( 1 + h ) λ - h}{λ} , h > 0 \qquad ( 29 )$$

is the transfer function of the time headway, having one pole at λ=0 and one Smith zero inside the unit disk, at λ=h/(1+h). By employing linearity in (28), the vehicle inter-spacing error zₖ that also contains a time-headway H can be rewritten as:

zₖ [symbol] [symbol] ₖ₋₁−H* [symbol] ₖ= [symbol] Φₖ*(Φₖ⁻¹Φₖ₋₁*uₖ₋₁−H*uₖ)+ [symbol] Φₖ₋₁*wₖ₋₁−H [symbol] Φₖ*wₖ (30)

Turning now to FIG. 5, note that in accordance to step 515, a control action uₖ[t] at the k-th vehicle for operating the vehicles platoon, which is also advantageous for the detection of abnormal road conditions, may be taken such as to satisfy the following condition:

Δuₖ=−Kₖ*zₖ, where (31a)

Δuₖ [symbol] Φₖ⁻¹Φₖ₋₁*uₖ₋₁−H*uₖ, for 2≤k≤n. (31b)

and Kₖ are the discrete time counterparts of the continuous time filters introduced in (22) and Φₖ, Φₖ₋₁ are the discrete time counterparts of the continuous time filters from (15). Turning now to FIG. 6, if the control action from (31) is written in the equivalent form:

uₖ=H⁻¹Φₖ⁻¹Φₖ₋₁*uₖ₋₁+Kₖ*zₖ (32)

then the control action uₖ can be developed on board the k-th vehicle as described in FIG. 6 for the vehicles with k=2 and k=3, respectively.

Also, in accordance to step 515 of FIG. 5, a control action uₖ at the k-th vehicle, satisfying (31) can be developed on board the k-th vehicle, as long as the zₖ vehicle inter-spacing error and the predecessor's control signal uₖ₋₁ are available in real time to the k-th vehicle. Turning now to FIG. 6, an arrangement that can accommodate control actions satisfying (31) is described for the first three vehicles in the platoon. Turning now to FIG. 4, it follows from (31b) that the uₖ control action can be developed on board the k-th vehicle in order to perform step 411, using digital filters such as: a H⁻¹Kₖ filter applied to the zₖ signals in accordance to step 403 and a H⁻¹Φₖ⁻¹Φₖ₋₁ filter applied to the uₖ₋₁ signal in accordance to step 405.

We denote the following platoon coupling TFM Γ(λ) as:

$$Γ ( λ ) {=}^{def} [ \begin{matrix}- H & O & O & ⋯ & O & O & O \\ {Φ}_{2}^{- 1} {Φ}_{1} & - H & O & ⋯ & O & O & O \\ O & {Φ}_{3}^{- 1} {Φ}_{2} & - H & ⋯ & O & O & O \\ ⋮ & ⋮ & ⋮ & & ⋮ & ⋮ & ⋮ \\ O & O & O & ⋯ & - H & O & O \\ O & O & O & ⋯ & {Φ}_{n - 1}^{- 1} {Φ}_{n - 2} & - H & O \\ O & O & O & ⋯ & O & {Φ}_{n}^{- 1} {Φ}_{n - 1} & - H\end{matrix} ] . \qquad ( 33 )$$

and observe that Γ(λ) is an invertible TFM and that the platoon's plant TFM G, defined herein in (13), satisfies:

G= [symbol] { [symbol] Φ₁, [symbol] Φ₂ . . . [symbol] Φₙ}Γ (34)

and equivalently

GΓ⁻¹= [symbol] { [symbol] Φ₁, [symbol] Φ₂ . . . [symbol] Φₙ}. (35)

In order to simplify the description, the following aggregated notation is needed, describing for the entire platoon the signals defined in (31b) for the k-th vehicle:

$$Δ u {=}^{def} [ \begin{matrix}- H ★ {u}_{1} \\ - H ★ {u}_{2} + {Φ}_{2}^{- 1} {Φ}_{1} ★ {u}_{1} \\ - H ★ {u}_{3} + {Φ}_{3}^{- 1} {Φ}_{2} ★ {u}_{2} \\ ⋮ \\ - H ★ {u}_{n - 1} + {Φ}_{n - 1}^{- 1} {Φ}_{n - 2} ★ {u}_{n - 2} \\ - H ★ {u}_{n} + {Φ}_{n}^{- 1} {Φ}_{n - 1} ★ {u}_{n - 1}\end{matrix} ] \qquad ( 36 )$$

and note that the Δu signals are related to the control actions u at the vehicles in the platoon via Δu=δ*u and equivalently:

u=δ⁻¹*Δu. (37)

Note that (35) implies that once the Δu signals have been specified, the control actions u at the vehicles in the platoon can always be developed from the Δu signals, via practically implementable digital filters described by the Γ⁻¹ TFM.

In order to simplify the description, the following matrix form description for the entire platoon of the condition introduced in (31) for the k-th vehicles is needed:

$$Δ u = - [ \begin{matrix}{K}_{1} & O & O & ⋯ & O & O \\ O & {K}_{2} & O & ⋯ & O & O \\ O & O & {K}_{3} & ⋯ & O & O \\ O & O & O & ⋱ & O & O \\ ⋮ & ⋮ & ⋮ & ⋱ & ⋮ & O \\ O & O & O & ⋯ & O & {K}_{n}\end{matrix} ] ★ [ \begin{matrix}{z}_{1} \\ {z}_{2} \\ {z}_{3} \\ ⋮ \\ {z}_{n - 1} \\ {z}_{n}\end{matrix} ] \qquad ( 38 )$$

Turning now to FIG. 7, the equations describing the feedback loop from the Δu signals defined in (36) to the vehicle inter-spacing distances z are given by

z= [symbol] { [symbol] Φ₁, [symbol] Φ₂ . . . [symbol] Φₙ}*Δu+ [symbol] Φ₀V₁*(u₀+w₀)+G*w, (39a)

Δu=− [symbol] {K₁,K₂ . . . Kₙ}*z, (39b)

where Kₖ are the discrete time counterparts of the continuous time filters introduced in (22) and Φₖ, Φₖ₋₁ are the discrete time counterparts of the continuous time filters from (15).

Also with respect to FIG. 7, It will become apparent to those skilled in the art, that due to the block diagonal form of both the plant [symbol] { [symbol] Φ₁, [symbol] Φ₂ . . . [symbol] Φₙ} and of the controller - [symbol] {K₁, K₂ . . . Kₙ} appearing in equations (39), the resulted feedback loop is entirely decoupled. Consequently, the n subsequent regulation problems of the zₖ vehicle inter-spacing distances from the Δuₖ signals are entirely decoupled and advantageously, the regulation problem with respect to the Δuₖ signal can be solved in a completely decentralized, individual manner for each vehicle 1≤k≤n, as described in detail herein. The Δu signals introduced in (36) are needed to emphasize the aforementioned closed loop decoupling and is also useful to the simplicity of the description.

The explicit form of (39a) reads:

$$[ \begin{matrix}{z}_{1} \\ {z}_{2} \\ {z}_{3} \\ ⋮ \\ {z}_{n}\end{matrix} ] = [ \begin{matrix}{Φ}_{1} & 𝒪 & 𝒪 & ⋯ & 𝒪 \\ 𝒪 & {Φ}_{2} & 𝒪 & ⋯ & 𝒪 \\ 𝒪 & 𝒪 & {Φ}_{3} & ⋯ & 𝒪 \\ ⋮ & ⋮ & ⋮ & & ⋮ \\ 𝒪 & 𝒪 & 𝒪 & ⋯ & {Φ}_{n}\end{matrix} ] \text{} ★Δ \text{} u + [ \text{} \begin{matrix}1 \\ 𝒪 \\ 𝒪 \\ ⋮ \\ 𝒪\end{matrix} ] \text{} \text{} {Φ}_{0} \text{} ★ ( \text{} {u}_{0} + {w}_{0} ) + [ \text{} \begin{matrix}{Φ}_{1} & 𝒪 & 𝒪 & ⋯ & 𝒪 \\ 𝒪 & {Φ}_{2} & 𝒪 & ⋯ & 𝒪 \\ 𝒪 & 𝒪 & {Φ}_{3} & ⋯ & 𝒪 \\ ⋮ & ⋮ & ⋮ & & ⋮ \\ 𝒪 & 𝒪 & 𝒪 & ⋯ & {Φ}_{n}\end{matrix} ] Γ ( λ ) ★ [ \begin{matrix}{w}_{1} \\ {w}_{2} \\ {w}_{3} \\ ⋮ \\ {w}_{n}\end{matrix} ] .$$

A detailed description is provided next for the computation of the values of the pre-determined bounds on the signals of interest for the evolution of the platoon such as: state estimation errors on the states of the vehicle's dynamical model or on the states of a dynamical model for the platoon, pre-determined bounds on the vehicle inter-spacing distances and on the residual signals. A minimal state-space representation (A, B, C) for the strictly-proper TFM

$$[ \begin{matrix}{Φ}_{1} & 𝒪 & 𝒪 & ⋯ & 𝒪 \\ 𝒪 & {Φ}_{2} & 𝒪 & ⋯ & 𝒪 \\ 𝒪 & 𝒪 & {Φ}_{3} & ⋯ & 𝒪 \\ ⋮ & ⋮ & ⋮ & & ⋮ \\ 𝒪 & 𝒪 & 𝒪 & ⋯ & {Φ}_{n}\end{matrix} ] ,$$

where each of the matrices A, B and C is block-diagonal is needed and may be developed. The state equations for the entire platoon are given by:

$$Δ x [ t + 1 ] = A Δ x [ t ] + B Δ u [ t ] + B [ \begin{matrix}{V}_{1} {Φ}_{1}^{- 1} ( λ ) {Φ}_{0} ( λ ) & Γ ( λ ) ] ★ [ \begin{matrix}( {u}_{0} [ t ] + {w}_{0} [ t ] ) \\ w [ t ]\end{matrix} ]\end{matrix} \qquad ( 41 a )$$

$$z [ t ] = C Δ x [ t ] + Ev [ t ] \qquad ( 41 b )$$

where in (41) the control u₀[t] of the leading vehicle may be included in the disturbance w₀[t], since it represents a reference signal for the entire platoon, while v[t] denoted the bounded measurement noise of the ranging sensors and Vᵢ is the first column in the Euclidean basis of [symbol] . Note that E can also be always considered to be block-diagonal, and partitioned in accordance with the (A, B, C) realization.

Turning now to FIG. 5, according to step 520, the following bounds on the road disturbances and on the measurement errors are being gathered: ∥w₀[t]∥_{∞}≤w̅₀, ∥w[t]∥_{∞}≤w̅ and ∥v[t]∥_{∞}≤v̅. Taking into accounts these bounds, the bounds on the filtered disturbances

$$\tilde{w} [ t ] {=}^{def} [ {V}_{1} ( {Φ}_{1}^{- 1} {Φ}_{0} ) Γ ( z ) ] ★ [ \begin{matrix}( {u}_{0} [ t ] + {w}_{0} [ t ] ) \\ w [ t ]\end{matrix} ] \qquad ( 42 )$$

may be obtained in accordance to methods for the computation of disturbance invariant sets for discrete time LTI systems. The bound of the filtered disturbances is further denoted as \tilde{w̅}.

The expression of a state-estimator \hat{Δ}x for the vehicle platoon dynamical equations from (41), is given by

\hat{Δ}x[t+1]=A\hat{Δ}x[t]+BΔu[t]+L(z[t]−\hat{z}[t]) (43a)

\hat{z}[t]=C\hat{Δ}x[t] (43b)

where the L block-diagonal state feedback matrix is chosen such that to assign all eigenvalues of (A−LC) inside the unit circle.

The pre-determined bounds on the state estimation error are computed first and subsequently employed for the computation of the pre-determined bounds on the vehicle inter-spacing distances. Depending on the chosen form of the residual signals, an additional step for the computation of the pre-determined bounds on the residuals may be performed, based on the pre-determined bounds on the state estimation error and on the vehicle inter-spacing distances. In accordance with an aspect of the invention, use is made of the known concept of set invariance. Turning to FIG. 5, in accordance to step 525, positive or controlled invariant sets, which characterize the dynamic evolution of the platoon of vehicles will provide the values of the aforementioned pre-determined bounds. The invariant sets may be chosen for example to be ellipsoidal sets, polyhedral sets, spectrahedron sets or star-shaped sets.

Also with respect to step 525 of FIG. 5, the dynamics (41)-(43) may be considered simultaneously, such that the associated invariant set is computed in a “lifted” space and then projected to the subspace of interest, or separately. Note that under linear(ized) dynamics, the plant and observer dynamics are implicitly separated and the bounds characterizing the state and its estimate can be computed separately. When considering nonlinear dynamics, switched or time-varying, the construction may be more convoluted but can be ultimately performed via similar methods. In general, the differences imposed by the nature of the dynamics and by the family of sets selected for representation, manifest quantitatively tighter bounds, more computational resources required, etc but not qualitatively. Therefore, and for the ease of the description, an iterative approach by assuming a sequential scheme where the bounds are computed iteratively and are represented through polyhedral sets is provided.

Described next is the step employed to determine the bounds of the estimation error dynamics \tilde{Δ}x[t]=Δx[t]−\hat{Δ}x[t]. These dynamics are obtained from (41) and (43):

\tilde{Δ}x[t+1]=(A−LC)\tilde{Δ}x[t]−LEv[t]+B\tilde{w}[t] (44a)

\tilde{z}[t]=C\tilde{Δ}x[t]+Ev[t] (44b)

yielding the following bounds for the state estimation error: |\tilde{Δ}x[t]|≤\overline{\tilde{Δ}x}.

Described next is the step for developing the state-feedback law and the pre-determine bound for the vehicle inter-spacing distances. The state-feedback law has the form:

Δu=−K_{d}\hat{Δ}x (45)

where the state-feedback matrix may advantageously be chosen to be block diagonal:

$${K}_{d} = [ \begin{matrix}{K}_{1} & O & O & … & O & O \\ O & {K}_{2} & O & … & O & O \\ O & O & {K}_{3} & … & O & O \\ O & O & O & ⋱ & O & O \\ ⋮ & ⋮ & ⋮ & ⋱ & ⋮ & O \\ O & O & O & … & O & {K}_{n}\end{matrix} ] \qquad ( 46 )$$

The developed feedback-law achieves a distributed and optimal disturbance rejection level μ* in presence of bounded road disturbances, measurement noise and estimation errors. In other words, for zero error initial conditions z[0]=0 the closed-loop system errors must satisfy:

∥z[t]∥≤μ*, ∀t. (47)

An intermediary step for reaching (47) is to compute the bounds characterizing the closed-loop state dynamics (44a) in which the feedback loop (45) has been introduced:

Δx[t+1]=(A−BK_{d})•x[t]+BK_{d}\tilde{Δ}x+B\tilde{w} (48)

where we used the fact that \hat{Δ}x=Δx−\tilde{Δ}x and with \tilde{w}[t] the notation for the filtered disturbances from (42).

Turning to FIG. 5, and the subsequent step 525, for dynamics (48) and a candidate RPI set of form {x:|Fx|≤v·1} the pair (K*_{d}, μ*) taken as in (46)-(47) exists if the following optimization problem is feasible:

$$( {K}_{d}^{*} , {ν}^{*} ) = arg {min}_{{K}_{d} . S , ν , \tilde{w} , υ} ν \qquad ( 49 )$$

$$subject to \vert \tilde{w} \vert \leq \overline{\tilde{w}} , \vert υ \vert \leq \overline{υ}$$

$$ν \geq 0 , SF = F ( A - B {K}_{d} )$$

$$ν \vert S \cdot 1 \vert + {max}_{υ} ( - B {K}_{d} E υ ) + {max}_{\tilde{w}} ( B \tilde{w} ) \leq ν \cdot 1$$

in which case the optimal vehicle inter-spacing error attenuation is provided by μ*, obtained from

$${μ}^{*} = \vert C \vert {ν}^{*} + {max}_{υ} ( E υ ) \qquad ( 50 )$$

where the max and |⋅| operators are interpreted elementwise and 1 denotes the column vector of appropriate dimension, having all its entries equal to 1. Note that due to the symmetric nature of the sets it may be assumed that

$${max}_{x} \vert Ax \vert = {max}_{x} Ax in ( 49 ) .$$

Also in FIG. 5, and the subsequent step 525, a candidate RPI set {x:|Fx|≤v·1} with respect to the dynamical evolution (49) is tested by deciding whether there exists a scaling of this set and a suitable feedback, rendering the set RPI. If so, a simple projection onto the output space will give the vehicle inter-spacing error bounds. Therefore, choosing matrix F can greatly influence the outcome of the construction. A simple choice e.g., taking F to be equal to the identity matrix, may be taken, but more complex shapes are also possible.

The optimization problem (49) is bilinear and can be solved based on linear programming (LP) solvers and line search with respect to v (or for that fact, through any other method which handles nonlinear formulations). An alternative method is to solve (49) in a two stage process, which first builds the state feedback gain and second obtains the attenuation factor. An exemplary method is to separate the computation of terms S, K*_{d} from the computation of the scaling factor v* in order to avoid the nonlinearities appearing in the initial formulation (49)-(50), as described in detail next.

The first stage obtains the decentralized state feedback gain which ensures the positive invariance and contractiveness of the set |Δx[t]|≤1 by the resolution of the linear programming problem:

$$( {K}_{d}^{*} , {S}^{*} ) = arg {min}_{{K}_{d} , S , ϵ} ϵ \qquad ( 51 )$$

$$subject to 0 \leq ϵ \leq 1$$

$$SF = F ( A - {BK}_{d} ) , S \cdot 1 \leq ϵ \cdot 1$$

$${K}_{d} validates ( 46 ) ,$$

with ∈ an auxiliary term which states that the set |FΔx[t]|<1 is contractive under the disturbance-free dynamics Δx[t+1]=(A−BK_{d})Δx[t].

The second stage obtains the optimal attenuation factor v* and subsequently, μ* for the state feedback matrix K*_{d} from (45)-(46) and the associated matrix S* obtained in the first stage:

$$( {ν}^{*} ) = arg {min}_{ν , \tilde{w} , υ} ν \qquad ( 52 )$$

$$subject to \vert \tilde{w} \vert \leq \overline{\tilde{w}} , \vert υ \vert \leq \overline{υ}$$

$$ν \geq 0 , ν \vert S \cdot 1 \vert + {max}_{υ} ( B {K}_{d} E υ ) + {max}_{\tilde{w}} ( B \tilde{w} ) \leq ν \cdot 1.$$

Note that the max terms are “constant” from the point of view of the attenuation factor v*, as they simply represent the largest influences of the (filtered) noises and disturbances. As such, bounding terms for these components can be computed a priori and introduced in (52) without any loss of generality. In such a case, the only variable of the linear programming optimization problem remains v.

Turning now to FIG. 6, if the control action uₖ at the k-th vehicle is specified e.g. in the form (31b), then by performing the second stage of the process described herein at equation (52), the bound on vehicle inter-spacing error can be obtained.

Also in FIG. 6, once the optimal gain K*_{d} has been computed for the k-th vehicle by solving for example (51)-(52), then next by employing the gain K*_{d} and the systems used for the state estimator of the k-th block-row component of Δx in (43), the expression of the Kₖ filter on board the k-th vehicle can be retrieved, where 1≤k≤n. Furthermore, the control action uₖ at the k-th vehicle can be determined from (31) by the following LTI filtration:

uₖ[t]=H⁻¹Φₖ⁻¹Φₖ₋₁*uₖ₋₁[t]+H⁻¹Kₖ*zₖ[t]. (53)

Also in accordance to FIG. 5, in one embodiment of the invention the mechanism for the abnormal road conditions detection at step 535 is described in detail next. In one embodiment of the invention, the residual signals may be taken to be equal to the vehicle inter-spacing distances. Since the bounds (47) are based on the robust positive invariance of the closed-loop dynamics (48), if during the evolution in time of the vehicle inter-spacing distances the computed pre-determined bounds are being violated, it means that an abnormal road condition has occurred. Using the fact that |z[t]|≤μ*, it may be define a healthy residual set R_{H}:

R_{H}={z:|z|≤μ*} (54)

in which z[t] has to stay at all time instants while under healthy functioning, i.e., under normal road conditions. Hence, the abnormal road conditions detection mechanism may be implemented as a certain set membership validation:
z[t]∈R_{H} means that the system may functioning under normal road conditions;
z[t] [symbol] R_{H} means abnormal road conditions have occurred.
   The expression “may be functioning under normal road conditions” may be defined to cover both the possibilty that the vehicle functions under nominal feedback loop dynamics and the possibilty that the road disturbances have not caused the vehicle inter-spacing distances to evolve outside the pre-determined computed bounds.

The are various possible choices for the residual signals, for example the state estimation error (43a). In this case the information being used for abnormal road conditions detection is the estimation of both the vehicle's position and its velocity, as opposed to only the vehicle's inter-spacing error, which contains solely a position component. In such a case, the residual set may be chosen to be the one bounding the state estimator's evolution (48), that is, the set {x:|Fx|≤v*·1} defined earlier.

Also in accordance to FIG. 5 and the subsequent step 530, the following malfunctions may be treated as if they are abnormal road conditions in the functioning of the vehicle platoon:
the vehicle inter-spacing error measured by the k-th car, zₖ[t], is measured incorrectly due to sensor failure or weather conditions,
data regarding the control signal of the preceding car, uₖ₋₁[t], Φₖ₋₁ is no longer received at the k-th car,
the brake and throttle electro-hydraulic actuator on board the k-th vehicle is malfunctioning due to mechanical failure, weather conditions or command saturation.

A more in depth description is next provided of methods for the development of the control signal and of the control action which are able to compensate for the computational and communications induced time delays in accordance with the principles of the invention is provided next.

Turning to FIG. 5, in accordance to step 510, the following dynamical model for the longitudinal movement of the k-th vehicle may be employed, relating the brake and throttle control action uₖ(t) of the k-th vehicle to its position [symbol] ₖ(t) on the roadway and is represented as follows:

$$\dot{{y}_{k}} ( t ) = {υ}_{k} ( t ) , {\dot{υ}}_{k} ( t ) = {f}_{k} ( {υ}_{k} ( t ) ) + {u}_{k} ( t ) ; \qquad ( 55 a )$$

$${y}_{k} ( 0 ) = - {\sum }_{j = 0}^{k} {ℓ}_{j} , {υ}_{k} ( 0 ) = 0. \qquad ( 55 b )$$

where vₖ(t) denotes the instantaneous speed of the k-th vehicle, [symbol] ₖ is the initial inter-spacing distance between the k-th agent and its predecessor in the platoon and fₖ(⋅) is a function that describes the torque/speed characteristic of the k-th vehicle. The index “0” is reserved for the first vehicle, i.e. the leader vehicle in the platoon. In some embodiments, the leader vehicle does not need to transmit any data to any other vehicle in the platoon. The notation:

[symbol]

ₖ=Gₖ*uₖ (56)

denotes the input-output operator Gₖ of the dynamical system modeling the k-th vehicle from (55a), with the initial conditions (55b).

Omitting the time argument (t) for brevity, the inter-spacing and relative velocity error signals respectively, with respect to the p e platoon may be defined as

zₖ [symbol] [symbol] ₖ₋₁− [symbol] ₖ, zₖ^{v} [symbol] vₖ₋₁−vₖ for 1≤k≤n. (57)

The actual lengths of the vehicles, along with a desired offset for the errors may also be incorporated in the definitions of (57), without any loss of generality. By differentiating the first equation in (57) the following time evolution for the relative velocity error of the k-th vehicle results:

żₖ^{v}=fₖ₋₁(vₖ₋₁)−fₖ(vₖ)+uₖ₋₁−uₖ, (58)

Also in FIG. 5, in accordance to step 515, an illustrative brake and throttle control action at the k-th vehicle is given by:

uₖ=uₖ₋₁+βₖzₖ^{v}− [symbol] V_{k,k-1}(∥zₖ∥_{σ})−fₖ(vₖ)+fₖ₋₁(vₖ). (59)

where uₖ₋₁ represents the control signal received, for example, via wireless communications from the preceding vehicle; the function V_{k,k-1}(⋅), known as an Artificial Potential Function (APF), is a class C¹, nonnegative, radially unbounded function of ∥z∥_{σ} satisfying the following properties: (i) V_{k,k-1}(∥z∥_{σ})→∞ as (∥z∥_{σ})→0 and (ii) V_{k,k-1}(∥z∥_{σ}) has a unique minimum, which is attained at ∥z∥₂=δₖ, with δₖ being a positive constant; and the σ-norm of a vector x is defined as

$${‖ x ‖}_{σ} {=}^{def} \frac{1}{σ} [ \sqrt{1 + {‖ x ‖}_{2}^{2}} - 1 ] \qquad ( 60 )$$

where σ is a strictly positive constant Note that (60) is a class κ_{∞} function of ∥x∥₂² and is differentiable everywhere.

It is important that the control action (59) can be developed on board the k-th vehicle based only on received data and sensor measurements which are available in real time to the k-th vehicle. The control action uₖ can be decomposed into the sum of two components: firstly, the control signal uₖ₋₁(t) and the fₖ₋₁(⋅) function, which is a part of the predecessor's dynamical model, received from the preceding agent, for example via wireless communications and secondly the local component, denoted by

[symbol]

[symbol]

βₖzₖ^{v}− [symbol] V_{k,k-1}(∥zₖ∥_{σ})−fₖ(vₖ)+fₖ₋₁(vₖ). (61)

and which is based solely on a speedometer for measuring vₖ(t) and on the measurements (57), acquirable on board the k-th vehicle, for instance via on board, RADAR or LIDAR sensors or differential GPS. Turning to FIG. 4, the control action at the k-th agent can be developed in accordance to step 403 and step 405 via:

uₖ=uₖ₋₁+ [symbol] . (62)

Also, in FIG. 4, advantageously, the break and throttle control action (59) exhibits very good robustness properties with respect to the θ seconds communications and computational delays on the received control signal uₖ₋₁(t), for typical values of θ of approximatively 20 ms. such as those induced for example by the dedicated short range communications (DSRC) systems, used in the automotive industry. Therefore in certain embodiments of the invention, the break and throttle control action (59) is able to overcome the foregoing imitations of prior art systems in coping with time delays and time jittering caused by the transmission of data among the vehicles in the platoon. Therefore, (62) also performs a realization of step 409, from FIG. 4. Step 409 is followed on board the k-th vehicles, by step 411, where the control action is performed based on (62).

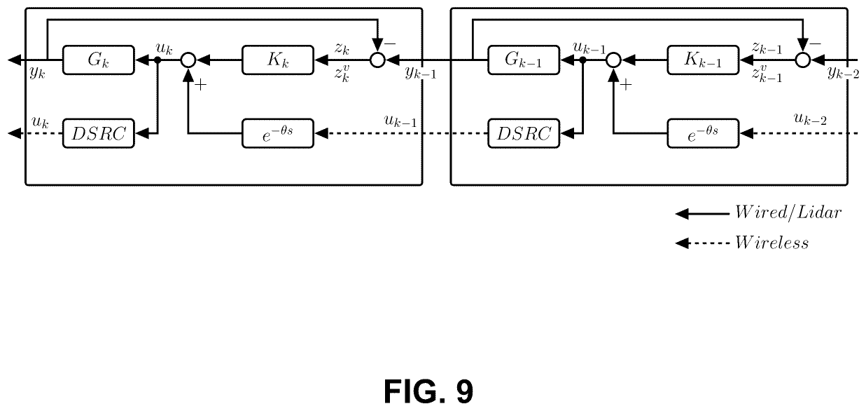

Turning now to FIG. 9, two consecutive vehicles in the platoon are described, e.g. vehicles 110B and 110C in FIG. 1. It is denoted with Kₖ the input-output operator from the zₖ, zₖ^{v} and vₖ measurements respective to the [symbol] signal (61) developed on board the k-th vehicle, namely:

[symbol]

=Kₖ*(zₖ,zₖ^{v},vₖ). (63)

From (59) and (58) the following closed-loop error evolutions at the k-th vehicle can be obtained:

żₖ^{v}=fₖ₋₁(vₖ₋₁)−fₖ₋₁(vₖ)−βₖzₖ^{v}+ [symbol] V_{k,k-1}(∥zₖ∥_{σ}). (64)

In an embodiment of the invention the supplemental correction term (fₖ₋₁(vₖ)−fₖ₋₁(vₖ)) included in the break and throttle control action (59) may be an acceleration correction term and it may allow for the automated operation of a heterogenous platoon in which at least two vehicles have distinct dynamical models, such as distinct torque/speed characteristics.

Under certain assumptions for the fₖ(⋅) function, the following Lyapunov candidate functions:

$${L}_{k} ( {z}_{k} ( t ) , {z}_{k}^{υ} ( t ) ) {=}^{def} \frac{1}{2} ( {V}_{k , k - 1} ( {‖ {z}_{k} ( t ) ‖}_{σ} ) + {z}_{k}^{υ T} ( t ) {z}_{k}^{υ} ( t ) ) , \qquad ( 65 )$$

$$with 1 \leq k \leq n ,$$

ensure that (A) for any real constant c>0 the sub-level sets Ω_{c}^{k} [symbol] {(zₖ, zₖ^{v})|Lₖ(zₖ, zₖ^{v})≤c} of Lₖ(⋅, ⋅) are compact and they represent forward invariant sets for the closed-loop evolution (64) at the k-th vehicle, where by closed-loop it is understood to mean the feedback loop from: the data received from transmitting vehicles and from the measurements made on board the receiving vehicle to the control action of the receiving vehicle;
(B) the control action (59) guarantee velocity matching in the steady-state i.e.

$${lim}_{t \to ∞} ‖ {z}_{k}^{υ} ( t ) ‖ = 0$$

and collision avoidance in the transient regime, i.e. there exists η_{c}>0 such that

∥zₖ(t)∥₂>η_{c}, ∀t≥0;

and (C) the control action (59) guarantees the formation's topology preservation in the steady-state, i.e.

$${lim}_{t \to ∞} {‖ {z}_{k} ( t ) ‖}_{2} = {δ}_{k}$$

where δₖ is a pre-specified real, positive value which may be specified when choosing the Lyapunov function.

Turning again to FIG. 9, the effect of a computational and communications induced time delay on each of the data inks, such as uₖ, with 1≤k≤(n−1) may be further be taken into account. For readability of the drawings, these time delays are figuratively denoted by e^{-θs} in FIG. 9, i.e., the Laplace transform of a delay of θ seconds, representative to the situation in which the delayed version uₖ(t−θ) version of the uₖ(t) signal is received on board of the (k+1) vehicle. These delays are caused by the physical imitations of the wireless communications system used, e.g. the transmission and processing time needed for the implementation of the data inks, entailing a θ time delay at the receiver. Also in FIG. 9, an embodiment employing the standard digital radio communications systems e.g. IEEE 802.11p—Dedicated Short Range Communications for inter-vehicle data transmission is described.

Considering that the platooning vehicles starts from following initial conditions

$${y}_{k} ( t ) = - {\sum }_{j = 0}^{k} {ℓ}_{j} , {υ}_{k} ( t ) = 0 , ∀ t ∈ ( - θ , 0 ] ,$$

then in accordance with the principles of the invention, the following constructed versions of the interspacing distance between the k-th vehicle and the (k−1)-th vehicle and the following constructed version of the relative speed between the k-th vehicle and the (k−1)-th vehicle may be defined as:

zₖ(t) [symbol] [symbol] ₖ₋₁(t−θ)− [symbol] ₖ(t)

zₖ^{v}(t) [symbol] vₖ₋₁(t−θ)−vₖ(t) for 1≤k≤n. (66)

The longitudinal control mechanism for the automated operation of the vehicle platoon may be designed so as to regulate the signals defined in (66).

It is important that the (66) regulated signals can be developed onboard board of the k-th vehicle, based exclusively on data received on board the k-th vehicle from the transmitting vehicles and on sensor measurements available on board the k-th vehicle. By performing the Taylor series expansion for [symbol] (t) and vₖ(t) respectively, the following expressions equivalent with (66) may be obtained:

zₖ(t)=zₖ(t−θ)−∫_{t-θ}^{t}vₖ(τ)dτ,

zₖ^{v}(t)=zₖ^{v}(t−θ)−vₖ(t)+vₖ(t−θ) (67)

Consequently, the signals defined in (66) can be developed on board the k-th vehicle via (67), using only onboard ranging sensors, such as LIDAR sensors and longitudinal speedometers in conjunction with an integrator. Specifically, the first term in (67) consists of the θ-delayed measurement of the inter-spacing distance minus the integration of the absolute speed vₖ, measurable on board the k-th vehicle over a θ-length interval. The second term in (67) consists of the θ-delayed measurement of the relative speed zₖ^{v} also measurable onboard the k-th vehicle, minus the (vₖ(t)−vₖ(t−θ)) term, comprised of absolute speeds measurable onboard the k vehicle. The entire history on the interval [(t−θ), t] of the ranging sensors (67) may be stored in a memory buffer and may be used by the longitudinal control mechanism for the automated operation of the platoon.

Turning now to FIG. 4, considering the definition of zₖ and zₖ^{v} as in (66), then in accordance with the principles of the invention the following break and throttle control action at the k-th vehicle can be performed at step 409, since it compensates the θ computational and communications time delays:

$$\{ \begin{matrix}\begin{matrix}{u}_{k} ( t ) = {u}_{k - 1} ( t - θ ) + {β}_{k} {z}_{k}^{υ} ( t ) + {∇}_{{y}_{k}} {V}_{k , k - 1} ( {‖ {z}_{k} ( t ) ‖}_{σ} ) - \\ {f}_{k} ( {υ}_{k} ) + {f}_{k - 1} ( {υ}_{k} )\end{matrix} \\ {u}_{k} ( t ) = 0 , ∀ t ∈ ( - θ , 0 ]\end{matrix} \qquad ( 68 )$$

Turning to FIG. 9, note that in order for the scheme to perform well it is desirable that the θ communications delay from uₖ₋₁(t−θ) to be replicated with high accuracy in the in zₖ(t), zₖ^{v}(t) measurements from (67). This may be performed by means of synchronous clocks or GPS time-base synchronization mechanism, using time-stamping protocols on the involved signals uₖ₋₁ and zₖ(t), zₖ^{v}(t), such as to implement with less than one milliseconds accuracy the θ delay from the definitions of zₖ(t), zₖ^{v}(t) regulated signals. If θ is chosen to be a “worst case scenario” time delay for the communications system employs for V2V communications, then the aforementioned synchronization may be used to implement time invariant, point-wise delays of value exactly θ, homogeneously throughout the entire platoon.

By choosing the Lyapunov function of the form (65) but where the definitions of zₖ(t), zₖ^{v}(t) are in accordance to (66), and assuming that the acceleration of the leader vehicle becomes zero after a finite period of time, i.e. v₀(t) reaches a steady-state, then sub-level sets Ω_{c}^{k} [symbol] {(zₖ, zₖ^{v})|Lₖ≤c, with c>0} of Lₖ are compact and they represent forward invariant sets for the closed-loop evolution of the k-th vehicle; the control action (68) guarantees velocity matching in the steady-state, i.e.

$${lim}_{t \to ∞} ‖ {z}_{k}^{υ} ( t ) ‖ = 0$$

and collision avoidance in the transient regime, i.e. there exists η_{c}>0 such that

∥zₖ(t)∥₂>η_{c}, ∀t≥0

and also guarantees the formation's topology preservation in the steady-state, i.e.

$${lim}_{t \to ∞} {‖ {z}_{k} ( t ) ‖}_{2} = {δ}_{k}$$

where δₖ is a pre-specified real, positive value.

What is claimed is:

1. A method of controlling a vehicle in a platoon comprising the steps of:
receiving at the vehicle, from another vehicle of the platoon, a control signal for use in controlling at least one of the group consisting of the throttle and the brake of the vehicle, the control signal being represented with respect to a dynamical model of a standardized model vehicle;
translating the received control signal into a corresponding translated control signal for the vehicle based on the vehicle's own dynamical model; and
setting at least one of the group consisting of: the throttle and the brake of the vehicle to a level based on the translated control signal.

2. The invention as defined in claim 1 wherein level of the one of the throttle and brake is further based on a distance between the receiving vehicle and the other vehicle.

3. The invention as defined in claim 2 wherein the distance between the receiving vehicle and the other vehicle is measured at the receiving vehicle.

4. The invention as defined in claim 2 wherein the distance between the receiving vehicle and the other vehicle is measured at the other vehicle.

5. The invention as defined in claim 1 wherein the platoon is a heterogeneous platoon such that at least the receiving vehicle and the other vehicle have different dynamical models.

6. The invention as defined in claim 1 wherein the sending vehicle and the receiving vehicle each have no knowledge of the other's dynamical model.

7. The invention as defined in claim 1 wherein the standardized model vehicle does not correspond to any vehicle in the platoon.

8. The invention as defined in claim 1 wherein the corresponding translated control signal represents an equivalent control action as was developed for the sending vehicle based on its own dynamical model but when effectuated on the standardized dynamical vehicle.

9. The invention as defined in claim 1 wherein the vehicle is a current vehicle in the platoon and the other vehicle is the immediate predecessor of the current vehicle.

10. The invention as defined in claim 1 wherein the control signal is developed in the other vehicle which is the immediate predecessor of the current vehicle.

11. The invention as defined in claim 1 wherein the translated control signal is developed using a dynamical model inversion method applied to the received control signal.

12. The invention as defined in claim 1 wherein the translated control signal is developed as a filtered variant of the received control signal based on the receiving vehicle's own dynamical mode

13. The invention as defined in claim 1 further comprising the steps:
determining that operation of the vehicle is not within at least one prescribed operating range due to at least one condition considered to effectively be a road condition; and
issuing a human perceivable alert indicating detection of an abnormal road condition.

14. The invention as defined in claim 1 further comprising the step of compensating the translated received control signal for delay thereof prior to using it in the applying step.

15. A method for use in controlling a vehicle in a platoon comprising the steps of:
developing an initial control signal for transmission from a vehicle of the platoon toward another vehicle of the platoon, the control signal being developed with respect to a dynamical model of the vehicle and being for use in controlling at least one of the group consisting of: the throttle and the brake of the other vehicle;
translating the initial control signal into a corresponding translated control signal for a dynamical model of a standardized model vehicle wherein the standardized dynamical model of a standardized model vehicle is known to both the vehicle and the other vehicle; and
transmitting information, based on the translated control signal, from the vehicle as a control signal for use in controlling at least one of the group consisting of the throttle and the brake of the other vehicle.

16. The invention as defined in claim 15 wherein the transmitted information is further based on a distance between the vehicle and the other vehicle.

17. The invention as defined in claim 15 wherein the transmitted information is received by the other vehicle, the method further comprising the step of:
translating the received control signal into a corresponding translated control signal for a dynamical model of the other vehicle; and
setting at least one of the group consisting of: the throttle and the brake of the other vehicle to a level based on the corresponding translated control signal for the dynamical model of the other vehicle.

18. The invention as defined in claim 15 wherein the transmitted information is received by the other vehicle, the method further comprising the step of:
translating the received control signal into a corresponding translated control signal for a dynamical model of the other vehicle; and setting at least one of the group consisting of the throttle and the brake of the other vehicle to a level based on the translated signal for a dynamical model of the other vehicle and a measured distance between the vehicle and the other vehicle.

19. The invention as defined in claim 15 wherein the transmitted information is further based on a distance between the vehicle and the other vehicle, the distance being measured at the vehicle.

20. The invention as defined in claim 15 wherein the translated control signal is developed using a dynamical model inversion method applied to the initial control signal as developed for the sending vehicle based on the sending vehicle's own dynamical model.

21. The invention as defined in claim 15 wherein the translated control signal is developed as a filtered variant of the initial control signal as developed for the sending vehicle based on the sending vehicle's own dynamical model.

22. A method for providing longitudinal control of a platoon of vehicles comprising the step of: regulating a constructed version of a signal based on the inter-spacing distance between any two specified vehicles of the platoon.

23. The invention as defined in claim 22 wherein:
the platoon has (n+1) vehicles, n being an integer equal to or greater than 2, where k denotes one of the specified vehicles of the platoon and has a range from 0 to n, where k=0 indicates a first vehicle of the platoon and k=n indicates a last vehicle of the platoon;
denotes an evolution in time of the absolute coordinate on the roadway with respect to an inertial reference system, of a k-th vehicle in the platoon so that [symbol] ₖ₋₁(t)− [symbol] ₖ(t) represents a distance at time t between the k th vehicle and its predecessor (k−1)-th vehicle which is the other specified vehicle of the platoon;
a control signal uₖ₋₁(t) is transmitted by the (k−1)-th vehicle is available at the k-th vehicle after a θ seconds delay as delayed version uₖ₋₁(t−θ); and
wherein [symbol] ₖ₋₁(t−θ)− [symbol] ₖ(t) is the constructed version of the signal.

24. The invention as defined in claim 22 wherein:
the platoon has (n+1) vehicles, n being an integer equal to or greater than 2, where k denotes one of the specified vehicles of the platoon and has a range from 0 to n, where k=0 indicates a first vehicle of the platoon and k=n indicates a last vehicle of the platoon; [symbol]
ₖ(t) denotes an evolution in time of the absolute coordinate on the roadway with respect to an inertial reference system, of a k-th vehicle in the platoon so that [symbol] ₖ₋ₓ(t)− [symbol] ₖ(t) represents a distance at time t between the k-th vehicle and the other specified vehicle of the platoon designated as vehicle x, where x ranges from 1 to n but is not equal to k;
a control signal uₖ₋₁(t) is transmitted by the x-th vehicle is available at the k-th vehicle after a θ seconds delay as delayed version uₖ₋ₓ(t−θ); and
developing the constructed signal at the k-th vehicle by subtracting an integration of the absolute speed of the k-th vehicle over a θ length interval from a θ delayed measurement of the interspacing distance with respect to vehicle x.

25. The invention as defined in claim 22 wherein the constructed version of the signal is regulated applying at least one of the group consisting of the throttle and the brake using a control action signal of a current vehicle based a control signal received at the current vehicle, the relative speed of the current vehicle with respect to vehicle transmitting the control signal, an artificial potential function, and a supplemental correction term.

26. The invention as defined in claim 22 wherein the constructed signal is developed on board a one of the two specified vehicles by subtracting the integration of the absolute speed of the one of the two specified vehicles over a length interval □ based on a □ delayed measurement of the interspacing distance with respect to the other of the two specified vehicles.

27. The invention as defined in claim 22 wherein a derivative with respect to a time variable t of the constructed version of the interspacing distance [symbol] ₖ₋₁t−θ)− [symbol] ₖ(t), which corresponds to a constructed version of the relative speed between the vehicles, is regulated.
